(19) United States
(12) Patent Application Publication
(10) Pub. No.: US 2025/0145786 A1
(43) Pub. Date: May 8, 2025

(54) HCFO-CONTAINING POLYURETHANE FOAM-FORMING COMPOSITIONS, RELATED FOAMS AND METHODS FOR THEIR PRODUCTION

(71) Applicant: Covestro LLC, Pittsburgh, PA (US)

(72) Inventors: Shawn G. Rider, Harrisville, PA (US); Jason D. Steranko, Wexford, PA (US); Brandon W. Parks, McKees Rocks, PA (US)

(21) Appl. No.: 18/387,544

(22) Filed: Nov. 7, 2023

(51) Int. Cl. C08J 9/14; C08G 18/10

(52) U.S. Cl. CPC C08J 9/144; C08G 18/10; C08G 2110/0075; C08J 2375/04

(57) ABSTRACT

Polyurethane foam-forming compositions, methods of producing polyurethane foams, polyurethane foams produced from such compositions made by such methods, as well as isocyanate-reactive compositions. The polyurethane foam-forming compositions include a polyol blend, a blowing agent composition, and a polyisocyanate. The polyol blend includes a hydroxyl-initiated polyether polyol having a functionality of 1.5 to less than 4.0 and an OH number of 200 to 600 mg KOH/g, a hydroxyl-initiated polyether polyol having a functionality of 4.0 to 8 and an OH number of 300 to 600 mg KOH/g, and an aromatic amine-initiated polyether polyol having a functionality of at least 2.5 and an OH number of 200 to 600 mg KOH/g. The polyol blend has a content of —C₂H₄O— units of 2 to 8% by weight, based on total weight of the polyol blend (or 1 to 5% by weight, based on the total weight of the polyurethane foam-forming composition). The blowing agent composition includes a hydrochlorofluoroolefin and water.

### FIELD

This specification pertains generally to hydrochlorofluoroolefin (“HCFO”)-containing isocyanate-reactive compositions, polyurethane foam-forming compositions, and polyurethane foams produced therefrom.

### BACKGROUND

Rigid polyurethane foams are used in numerous applications. They are produced by reacting a polyisocyanate and an isocyanate-reactive compound, usually a polyol, in the presence of a blowing agent. One use of such foams is as a thermal insulation medium in the construction of refrigerated storage devices, including refrigerated appliances and tractor trailers. The thermal insulating properties of closed-cell rigid foams are dependent upon a number of factors, including the average cell size and the thermal conductivity of the contents of the cells.

The thermal conductivity of the contents of the cells depends upon the blowing agent(s) used. Fluorocarbons have historically often been used because of their low thermal conductivity. However, fluorocarbons, including chlorofluorocarbons (“CFCs”), hydrofluorocarbons (“HFCs”) and hydrochlorofluorocarbons (“HCFCs”), are greenhouse gases that have been phased out of use. Halogenated olefins, such as HCFOs, are environmentally friendlier alternatives for such fluorocarbons, but they can be costly.

In addition, because most commercial foaming processes employ a pre-blend of the polyol, additives, and blowing agent, it is important that the isocyanate reactive blends are phase stable and do not separate over time.

As a result, it is highly desirable to identify ways to significantly reduce the amount of HCFOs needed in a formulation for producing a rigid polyurethane foam, provided that the thermal efficiency of the resulting foam is not detrimentally impacted to any significant extent. In addition, it is important that an isocyanate-reactive composition that is a pre-blend of polyol, blowing agent, catalyst, and surfactant, is phase stable and does not separate when stored for extended time periods.

The inventions described in this specification were made in view of the foregoing.

### SUMMARY

In some respects, this specification relates to isocyanate-reactive compositions. These isocyanate-reactive compositions comprise a polyol blend and a physical blowing agent composition. The polyol blend comprises: (1) 30% to 98% by weight, based on total weight of the polyol blend, of a first hydroxyl-initiated polyether polyol having a functionality of 1.5 to less than 4.0 and an OH number of 200 to 600 mg KOH/g; (2) 1 to 40% by weight, based on total weight of the polyol blend, of a second hydroxyl-initiated polyether polyol having a functionality of 4.0 to 8 and an OH number of 300 to 600 mg KOH/g; and (3) 1 to 30% by weight, based on total weight of the polyol blend, of an aromatic amine-initiated polyether polyol having a functionality of at least 2.5 and an OH number of 200 to 600 mg KOH/g. The polyol blend has a content of —C₂H₄O— units of 2 to 8% by weight, based on the total weight of the polyol blend. The blowing agent composition comprises (1) a physical blowing agent and (2) water, in which (i) the water is present in an amount of at least 1% by weight, based on the total weight of the isocyanate-reactive composition, (ii) the physical blowing agent comprises a hydrochlorofluoroolefin that is present in an amount of 5 to 25% by weight, based on total weight of the isocyanate-reactive composition, and in an amount of at least 80% by weight, based on total weight of the physical blowing agent present in the blowing agent composition; and (iii) the physical blowing agent and the water are present in a relative ratio, by weight, of at least 4:1.

In other respects, this specification relates to polyurethane foam-forming compositions. These polyurethane foam-forming compositions comprise a polyol blend, a blowing agent composition, and a polyisocyanate. The polyol blend comprises: (1) 30% to 98% by weight, based on total weight of the polyol blend, of a first hydroxyl-initiated polyether polyol having a functionality of 1.5 to less than 4.0 and an OH number of 200 to 600 mg KOH/g; (2) 1 to 40% by weight, based on total weight of the polyol blend, of a second hydroxyl-initiated polyether polyol having a functionality of 4.0 to 8 and an OH number of 300 to 600 mg KOH/g; and (3) 1 to 30% by weight, based on total weight of the polyol blend, of an aromatic amine-initiated polyether polyol having a functionality of at least 2.5 and an OH number of 200 to 600 mg KOH/g. The polyol blend has a content of —C₂H₄O— units of 2 to 8% by weight, based on the total weight of the polyol blend. The blowing agent composition comprises (1) a physical blowing agent and (2) water, in which (i) the water is present in an amount of at least 1% by weight, based on the total weight of the polyurethane foam-forming composition except for the weight of the polyisocyanate, (ii) the physical blowing agent comprises a hydrochlorofluoroolefin that is present in an amount of 5 to 25% by weight, based on total weight of the polyurethane foam-forming composition except for the weight of the polyisocyanate, and in an amount of at least 80% by weight, based on total weight of the physical blowing agent present in the blowing agent composition; and (iii) the physical blowing agent and the water are present in a relative ratio, by weight, of at least 4:1. The polyisocyanate is present in an amount sufficient to provide an isocyanate index of 0.9 to 1.5.

In still other respects, this specification relates to methods of producing a polyurethane foam. The methods comprise reacting, at an isocyanate index of 0.9 to 1.5, a polyurethane foam-forming composition comprising a polyol blend, a blowing agent composition, and a polyisocyanate. In these methods, the polyol blend comprises: (1) 30% to 98% by weight, based on total weight of the polyol blend, of a first hydroxyl-initiated polyether polyol having a functionality of 1.5 to less than 4.0 and an OH number of 200 to 600 mg KOH/g; (2) 1 to 40% by weight, based on total weight of the polyol blend, of a second hydroxyl-initiated polyether polyol having a functionality of 4.0 to 8 and an OH number of 300 to 600 mg KOH/g; and (3) 1 to 30% by weight, based on total weight of the polyol blend, of an aromatic amine-initiated polyether polyol having a functionality of at least 2.5 and an OH number of 200 to 600 mg KOH/g. The polyol blend has a content of —C₂H₄O— units of 2 to 8% by weight, based on the total weight of the polyol blend. The blowing agent composition comprises (1) a physical blowing agent and (2) water, in which (i) the water is present in an amount of at least 1% by weight, based on the total weight of the polyurethane foam-forming composition except for the weight of the polyisocyanate, (ii) the physical blowing agent comprises a hydrochlorofluoroolefin that is present in an amount of 5 to 25% by weight, based on total weight of the polyurethane foam-forming composition except for the weight of the polyisocyanate, and in an amount of at least 80% by weight, based on total weight of the physical blowing agent present in the blowing agent composition; and (iii) the physical blowing agent and the water are present in a relative ratio, by weight, of at least 4:1.

This specification is also directed to rigid polyurethane foams produced from such foam-forming compositions and by such methods, as well as to composite articles comprising such rigid foams and panel insulation that includes such rigid foams.

### DETAILED DESCRIPTION

Various implementations are described and illustrated in this specification to provide an overall understanding of the structure, function, properties, and use of the disclosed inventions. It is understood that the various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described implementations. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of the —OH functional material that is being described and, in the case of the polyether polyols described in this specification, is calculated by the functionality of the starting compounds employed to produce the polyether polyol. The term “hydroxyl number” refers to the number of reactive hydroxyl groups available for reaction and is expressed as the number of milligrams of potassium hydroxide equivalent to the hydroxyl content of one gram of the polyol (ASTM D4274-16). The term “equivalent weight” refers to the weight of a compound divided by its valence. For a polyol, the equivalent weight is the weight of the polyol that will combine with an isocyanate group and may be calculated by dividing the molecular weight of the polyol by its functionality. The equivalent weight of a polyol may also be calculated by dividing 56,100 by the hydroxyl number of the polyol−Equivalent Weight (g/eq)=(56.1×1000)/OH number.

The polyol blends described in this specification have a content of —C₂H₄O— units within a specified range. As used in this context, “a content of —C₂H₄O— units” refers to the calculated weight of —C₂H₄O— units present in a polyol that are formed during production of the polyol itself (as opposed to —C₂H₄O— units that may already be present in a reactant used to prepare the polyol). In the case of a polyether polyol that is an alkoxylation reaction product of an H-functional initiator and an alkylene oxide, for example, —C₂H₄O— units can result from use of ethylene oxide as an alkylene oxide and/or use of an H-functional initiator containing a —C₂H₄Z-group in which Z represents a Zerewitinoff-active hydrogen atom (sometimes also referred to merely as “active hydrogen”), such as can be the case where Z represents a hydrogen bonded to N, O or S. In the case of a polyester polyol that is a reaction product of a carboxylic acid and/or anhydride thereof with a hydroxyl-containing material, —C₂H₄Z— units may result, for example, from use of diethylene glycol as a hydroxyl-containing material. Thus, when it is stated herein that a polyol blend has a content of —C₂H₄O— units of 2% to 8% by weight, based on total weight of the polyol blend, it means that 2% to 8% by weight of the polyol blend, based on the total weight of the polyol blend, is —C₂H₄O— units formed during production of the polyol(s) that are used, as calculated based on the weight of materials used to make the polyols.

Certain implementations of the present specification relate to isocyanate-reactive compositions useful in the production of rigid foams. A rigid foam is characterized as having a ratio of compressive strength to tensile strength of at least 0.5:1, elongation of less than 10%, as well as a low recovery rate from distortion and a low elastic limit, as described in in “Polyurethanes: Chemistry and Technology, Part II Technology,” J. H. Saunders & K. C. Frisch, Interscience Publishers, 1964, page 239.

The rigid foams of this specification are the reaction product of a polyurethane-foam forming composition that includes a polyisocyanate. As used herein, the term “polyisocyanate” encompasses diisocyanates, as well as polyisocyanates of greater functionality than 2.0.

Any of the known organic isocyanates, modified isocyanates or isocyanate-terminated prepolymers made from any of the known organic isocyanates may be used. Suitable organic isocyanates include aromatic, aliphatic, and cycloaliphatic polyisocyanates and combinations thereof. Useful isocyanates include: diisocyanates such as m-phenylene diisocyanate, p-phenylene diisocyanate, 2,4-toluene diisocyanate, 2,6-toluene diisocyanate, 1,6-hexamethylene diisocyanate, 1,4-hexamethylene diisocyanate, 1,3-cyclohexane diisocyanate, 1,4-cyclo-hexane diisocyanate, isomers of hexahydro-toluene diisocyanate, isophorone diisocyanate, dicyclo-hexylmethane diisocyanates, 1,5-naphthylene diisocyanate, 4,4′-diphenylmethane diisocyanate, 2,4′-diphenylmethane diisocyanate, 4,4′-biphenylene diisocyanate, 3,3′-dimethoxy-4,4′-biphenylene diisocyanate and 3,3′-dimethyl-diphenyl-propane-4,4′-diisocyanate; triisocyanates such as 2,4,6-toluene triisocyanate; and polyisocyanates such as 4,4′-dimethyl-diphenylmethane-2,2′,5,5′-tetraisocyanate and the polymethylene polyphenyl-polyisocyanates.

Undistilled or crude polyisocyanates may also be used. The crude toluene diisocyanate obtained by phosgenating a mixture of toluene diamines and the crude diphenylmethane diisocyanate obtained by phosgenating crude diphenylmethanediamine (polymeric MDI) are examples of suitable crude polyisocyanates. Suitable undistilled or crude polyisocyanates are disclosed in U.S. Pat. No. 3,215,652.

Modified isocyanates are obtained by chemical reaction of diisocyanates and/or polyisocyanates. Useful modified isocyanates include, but are not limited to, those containing ester groups, urea groups, biuret groups, allophanate groups, carbodiimide groups, isocyanurate groups, uretdione groups and/or urethane groups. Examples of modified isocyanates include prepolymers containing NCO groups and having an NCO content of from 25 to 35 weight percent, such as from 29 to 34 weight percent, such as those based on polyether polyols or polyester polyols and diphenylmethane diisocyanate.

In certain implementations, the polyisocyanate comprises a methylene-bridged polyphenyl polyisocyanate and/or a prepolymer of methylene-bridged polyphenyl polyisocyanates having an average functionality of from 1.8 to 3.5, such as from 2.0 to 3.1, isocyanate moieties per molecule and an NCO content of from 25 to 32 weight percent, due to their ability to cross-link the polyurethane.

The isocyanate-reactive compositions described in this specification comprise a polyol blend. More specifically, the polyol blend comprises two different hydroxyl-initiated polyether polyols, in which a first such polyether polyol has a functionality of 1.5 to less than 4.0, such as 1.5 to 3.5, 2.5 to 3.5, or 2.8 to 3.2, and an OH number of 200 to 600 mg KOH/g, such as 300 to 500 mg KOH/g, 350 to 450 mg KOH/g, or 350 to 400 mg KOH/g, and a second such polyether polyol has a functionality of 4.0 to 8.0, such as 4.5 to 6.5, 5.0 to 6.0, or 5.3 to 5.7, and an OH number of 300 to 600 mg KOH/g, such as 300 to 500 mg KOH/g, 350 to 450 mg KOH/g, or 350 to 400 mg KOH/g.

Suitable hydroxyl-initiated polyether polyols are those which are an addition product of alkylene oxide onto one or more OH-functional initiators. As will be appreciated, such hydroxyl-initiated polyether polyols (as well as any other polyether polyols described in this specification) can be prepared by conducting the addition reaction of an alkylene oxide onto one or more initiators in the presence of a suitable catalyst, such as basic catalysts (such as sodium or potassium hydroxide or tertiary amines such as methyl imidazole) and double metal cyanide (DMC) catalysts. Examples of useful OH-functional initiators are, without limitation, water, ethylene glycol, diethylene glycol, butyl diglycol, glycerol, diethylene glycol, trimethylolpropane, propylene glycol, pentaerythritol, sorbitol, sucrose, triethanolamine, 1,4-butanediol, 1,6-hexanediol and low molecular weight hydroxyl-containing esters of such polyols with dicarboxylic acids, among many others. As used herein, “OH-functional initiator” refers to initiators that contain hydroxyl (OH) groups as the only Zerevitinov-active hydrogens present on the molecule. Generally, groups with Zerevitinov-active hydrogen are understood in the art to mean hydroxyl (OH), amino (NHₓ), and thiol (SH) groups.

As will be appreciated, it is possible to use other initiators, such as amine-functional and alcohol-amine functional initiators in combination with the OH-functional initiator to prepare the hydroxyl-initiated polyether polyols described herein. In some implementations, however, OH-functional initiator(s) are the predominant or essentially sole initiator(s) used to produce the hydroxyl-initiated polyether polyol. This means that, in these implementations, OH-functional initiator is present in an amount of more than 50% by weight, such as at least 80% by weight, at least 90% by weight, or even 100% by weight, based on the total weight of H-functional initiator used to produce the hydroxyl-initiated polyether polyol.

A variety of alkylene oxides may be used to produce the foregoing hydroxyl-initiated polyether polyols, such as ethylene oxide, propylene oxide, butylene oxide, amylene oxide and mixtures thereof. The alkylene oxides may be added individually, sequentially one after the other to form blocks or in a mixture to form a heteric polyether. The hydroxyl-initiated polyether polyols may have primary or secondary hydroxyl end groups. In some implementations, propylene oxide is the primary or essentially sole alkylene oxide used to prepare each of the hydroxyl-initiated polyether polyols. This means that, in these implementations, propylene oxide is used in an amount of more than 50% by weight, such as at least 60% by weight, at least 70% by weight, at least 80% by weight, at least 90% by weight, or even 100% by weight, based on the total weight of alkylene oxide used to prepare each of the hydroxyl-initiated polyether polyols. In some implementations, ethylene oxide is employed in a relatively small amount. In these implementations, ethylene oxide is used in an amount of less than 50% by weight, no more than 40% by weight, no more than 30% by weight, no more than 20% by weight, no more than 10% by weight, no more than 5% by weight, no more than 1% by weight, or, in some cases, 0% by weight, based on the total weight of alkylene oxide used to prepare each of the hydroxyl-initiated polyether polyols.

Even more specifically, in some cases, propylene oxide is used in an amount of at least 80% by weight, at least 90% by weight, or even 100% by weight, based on the total weight of alkylene oxide used to prepare the first hydroxyl-initiated polyether polyol having a functionality of 1.5 to less than 4.0 and an OH number of 200 to 600 mg KOH/g, and ethylene oxide is used in an amount of no more than 20% by weight, no more than 10% by weight, no more than 5% by weight, no more than 1% by weight, or, in some cases, 0% by weight, based on the total weight of alkylene oxide used to prepare the first hydroxyl-initiated polyether polyol having a functionality of 1.5 to less than 4.0 and an OH number of 200 to 600 mg KOH/g. Further, in some cases, propylene oxide is used in an amount of 60 to 90% by weight, 60 to 80% by weight, or 65 to 75% by weight, based on the total weight of alkylene oxide used to prepare the second hydroxyl-initiated polyether polyol having a functionality of 4.0 to 8 and an OH number of 300 to 600 mg KOH/g, and ethylene oxide is used in an amount of 10% to 40% by weight, 20 to 40% by weight, or 25 to 35% by weight, based on the total weight of alkylene oxide used to prepare the second hydroxyl-initiated polyether polyol having a functionality of 4.0 to 8 and an OH number of 300 to 600 mg KOH/g.

The first hydroxyl-initiated polyether polyol having a functionality of 1.5 to less than 4.0 and an OH number of 200 to 600 mg KOH/g is present in an amount of 30% to 98% by weight, such as 30% to 80% by weight, 30% to 70% by weight, 40% to 60% by weight, or 45% to 55% by weight, based on total weight of the polyol blend. In addition, the second hydroxyl-initiated polyether polyol having a functionality of 4.0 to 8 and an OH number of 300 to 600 mg KOH/g is present in an amount of 1% to 40% by weight, such as 10% by to 40% by weight, or 20% to 30% by weight, based on total weight of the polyol blend.

In some cases, the first hydroxyl-initiated polyether polyol having a functionality of 1.5 to less than 4.0 and an OH number of 200 to 600 mg KOH/g has a content of —C₂H₄O— units of less than 10% by weight, such as less than 5% by weight, less than 2% by weight, or, in some cases, 0% by weight, based on total weight of the first hydroxyl-initiated polyether polyol. Further, in some cases, the second hydroxyl-initiated polyether polyol having a functionality of 4.0 to 8 and an OH number of 300 to 600 mg KOH/g has a content of —C₂H₄O— units of 10% to 50% by weight, such as 10% to 40% by weight, 10% to 30% by weight, or 15% to 25% by weight, based on total weight of the second hydroxyl-initiated polyether polyol.

The polyol blend further comprises an aromatic amine-initiated polyether polyol. As used herein, “aromatic amine-initiated polyether polyol” refers to a polyether polyol that is the reaction product of an H-functional initiator comprising an aromatic amine, such as toluenediamine (“TDA”), with alkylene oxide.

In certain implementations, aromatic amine employed has an amine functionality of at least 1, such as 1 to 3 or 1 to 2. Specific examples of suitable aromatic amines which can be used include crude TDA obtained by the nitration of toluene followed by reduction; 2,3-TDA, 3,4-TDA, 2,4-TDA, 2,6-TDA or mixtures thereof, aniline; 4,4′-methylene dianiline; methylene-bridged polyphenyl polyamines composed of isomers of methylene dianilines and triamines or polyamines of higher molecular weight prepared by reacting aniline with formaldehyde by methods known in the art. In some implementations, a mixture composed of 2,3-TDA and 3,4-TDA (commonly referred to as “o-TDA”) is used.

In addition to the aromatic amine, other H-functional initiators may also be used to prepare the aromatic amine-initiated polyether polyol. These other H-functional initiators include, for example, water, propylene glycol, glycerin, ethylene glycol, ethanol amines, diethylene glycol, or a mixture of any two or more thereof. As will be appreciated, it is possible to use a wide variety of individual initiators in combination with one another. In some implementations, however, aromatic amine is the predominant or essentially sole H-functional initiator used to produce the aromatic amine-initiated polyether polyol. This means that, in these implementations, aromatic amine is present in an amount of more than 50% by weight, such as at least 80% by weight, at least 90% by weight, or even 100% by weight, based on the total weight of H-functional initiator used to produce the aromatic amine-initiated polyether polyol.

A variety of alkylene oxides may be used to produce the aromatic amine-initiated polyether polyol, such as ethylene oxide, propylene oxide, butylene oxide, amylene oxide and mixtures thereof. The alkylene oxides may be added individually, sequentially one after the other to form blocks or in a mixture to form a heteric polyether. The aromatic amine-initiated polyether polyols may have primary or secondary hydroxyl end groups. In some implementations, propylene oxide is the primary or essentially sole alkylene oxide used to prepare the aromatic amine-initiated polyether polyol. This means that, in these implementations, propylene oxide is used in an amount of more than 50% by weight, such as at least 80% by weight, at least 90% by weight, or even 100% by weight, based on the total weight of alkylene oxide used to prepare the aromatic amine-initiated polyether polyol. In some implementations, ethylene oxide is employed in a relatively small amount. In these implementations, ethylene oxide is used in an amount of no more than 10% by weight, no more than 5% by weight, no more than 1% by weight, or, in some cases, 0% by weight, based on the total weight of alkylene oxide used to prepare the aromatic amine-initiated polyether polyol.

As indicated earlier, the aromatic amine-initiated polyether polyol has an OH number of 200 to 600 mg KOH/g and a functionality of at least 2.5. In some implementations, the aromatic amine-initiated polyether polyol has an OH number of 300 to 500 mg KOH/g, 350 to 450 mg KOH/g or 380 to 420 mg KOH/g, and a functionality of 2.5 to 4.5, 3.5 to 4.5, 3.8 to 4.2 or 4.0. In addition, the aromatic amine-initiated polyether polyol, in some implementations, has a content of —C₂H₄O— units of less than 10% by weight, such as less than 5% by weight, less than 2% by weight, or, in some cases, 0% by weight, based on total weight of the aromatic amine-initiated polyether polyol.

The aromatic amine-initiated polyether polyol is present in an amount of 1% to 30% by weight, based on the total weight of the polyol blend. More specifically, in some implementations, the aromatic amine-initiated polyol is present in an amount of 1% to 25% by weight, such as 10% to 20% by weight, or 10% to 15% by weight, based on the total weight of the polyol blend.

If desired, the polyol blend may include additional compounds that contain isocyanate-reactive groups, such as chain extenders and/or crosslinking agents, polyester polyols and other polyether polyols not described above. Chain extenders and/or crosslinking agents include, for example, ethylene glycol, propylene glycol, butylene glycol, glycerol, diethylene glycol, dipropylene glycol, dibutylene glycol, trimethylolpropane, pentaerythritol, ethylene diamine, and diethyltoluenediamine.

In some implementations, the polyol blend may include an aromatic polyester polyol. Suitable aromatic polyester polyols include, for example, the reaction product of an aromatic diacid or anhydride with a suitable glycol or triol. For example, polyester polyols can be the reaction product of a glycol and/or triol, such as ethylene glycol, propylene glycol, butylene glycol, 1,3-butanediol, neopentyl glycol, diethylene glycol, dipropylene glycol, triethylene glycol, tripropylene glycol, glycerol, trimethylolethane, trimethyolpropane, pentanediol, hexanediol, heptanediol, 1,3- and 1,4-dimethylol cyclohexane, or a mixture of any two or more thereof with an aromatic diacid or aromatic anhydride, such as, for example, phthalic acid, isophthalic acid, terephthalic acid, phthalic anhydride, or a mixture of any two or more thereof. Some of examples of the suitable aromatic polyester polyols include those compounds which are available from Stepan Chemical under the Stepanpol trade name such as, for example, Stepanpol® PS 3024 and Stepanpol PS 2502A or from Invista under the Terate trade name, such as Terate® HT-5100 and HT-5500, or from Coim under the Isoexter trade name such as Isoexter® TB-265.

In certain implementations, the aromatic polyester polyol has an OH number of 150 to 410 mg KOH/g, such as 150 to 360 mg KOH/g, such as 200 to 335 mg KOH/g, or, in some cases, 200 to 250 mg KOH/g, and a functionality of 1.5 to 3, such as 1.9 to 2.5. In some implementations, the aromatic polyester polyol has a content of —C₂H₄O— units of less than 50% by weight, based on total weight of the aromatic polyester polyol.

In some implementations, aromatic polyester polyol is present in an amount of up to 10% by weight, such as 1 to 10% by weight, or 5 to 10% by weight, based on total weight of the polyol blend. In other implementations, however, the polyol blend is substantially free, or completely free, of any polyether polyol. As used herein, “substantially free” when used with reference to the absence of polyester polyol in the polyol blend, means that polyester polyol is present in an amount of less than 1% by weight, based on total weight of the polyol blend.

In some embodiments, the polyol blend comprises an alkanolamine-initiated polyether polyol. As used herein, “alkanolamine-initiated polyether polyol” refers to a polyether polyol prepared by reacting an alkylene oxide with one or more suitable initiators, in which the initiator comprises one or more alkanolamines.

As used herein, the term “alkanolamine” refers to compounds represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms. The dialkylene ether radical may be represented by the formula:

R—O—R—

where each R represents a hydrocarbon radical having 2 to 3 carbon atoms.

Specific examples of suitable alkanolamines that may be used in the preparation of the alkanolamine-initiated polyether polyol include monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, as well as mixtures of any two or more thereof.

In addition to the alkanolamine, other H-functional initiators may also be used to prepare the alkanolamine-initiated polyether polyol. These other H-functional initiators include, for example, water, propylene glycol, glycerin, ethylene glycol, ethanol amines, diethylene glycol, or a mixture of any two or more thereof. As will be appreciated, it is possible to use a wide variety of individual initiators in combination with one another. In some implementations, however, alkanolamine is the predominant or essentially sole H-functional initiator used to produce the alkanolamine-initiated polyether polyol. This means that, in these implementations, alkanolamine is present in an amount of more than 50% by weight, such as at least 80% by weight, at least 90% by weight, or even 100% by weight, based on the total weight of H-functional initiator used to produce the alkanol amine-initiated polyether polyol.

Suitable alkylene oxides for use in preparing the alkanolamine-initiated polyether polyol include ethylene oxide, propylene oxide, butylene oxide, styrene oxide, and epichlorohydrin, as well as mixtures of any two or more thereof. In some implementations, propylene oxide is the primary or essentially sole alkylene oxide used to prepare the alkanolamine-initiated polyether polyol. This means that, in these implementations, propylene oxide is used in an amount of more than 50% by weight, such as at least 80% by weight, at least 90% by weight, or even 100% by weight, based on the total weight of alkylene oxide used to prepare the alkanolamine-initiated polyether polyol. In some implementations, ethylene oxide is employed in a relatively small amount. In these implementations, ethylene oxide is used in an amount of no more than 10% by weight, no more than 5% by weight, no more than 1% by weight, or, in some cases, 0% by weight, based on the total weight of alkylene oxide used to prepare the alkanolamine-initiated polyether polyol.

In some implementations, the alkanolamine-initiated polyether polyol has an OH number of more than 500 mg KOH/g, such as more than 500 to 900 mg KOH/g, such as 600 to 800 mg KOH/g, or, in some cases, 680 to 720 mg KOH/g, and a functionality of 2.5 to 4, such as 2.5 to 3.5. Further, in some implementations, the alkanolamine-initiated, polyether polyol is present in an amount of 0.1 to 10% by weight, such as 1 to 10% by weight or 5 to 10% by weight, based upon the total weight of the polyol blend.

In some cases, the alkanolamine-initiated polyether polyol has a content of —C₂H₄O— units of less than 10% by weight, less than 5% by weight, less than 2% by weight, or 0% by weight, based on total weight of the alkanolamine-initiated polyether polyol.

In certain implementations, the first hydroxyl-initiated polyether polyol having a functionality of 1.5 to less than 4.0 and an OH number of 200 to 600 mg KOH/g and the second hydroxyl-initiated polyether polyol having a functionality of 4.0 to 8 and an OH number of 300 to 600 mg KOH/g are present in a weight ratio of 1:5 to 5:1, such as 1:1 to 5:1, 1:1 to 3:1 or 1.5:1 to 2.5:1. In some implementations, the first hydroxyl-initiated polyether polyol having a functionality of 1.5 to less than 4.0 and an OH number of 200 to 600 mg KOH/g and the aromatic amine-initiated polyether polyol are present in a weight ratio of 1:1 to 5:1, such as 1:1 to 4:1, 1:1 to 3:1, or 2:1 to 3:1. In some implementations, the second hydroxyl-initiated polyether polyol having a functionality of 4.0 to 8 and an OH number of 300 to 600 mg KOH/g and the aromatic amine-initiated polyether polyol are present in a weight ratio of 1:2 to 2:1, such as 1:1 to 2:1, or 1:1 to 1.5:1.

In certain implementations, the polyol blend has a weighted average functionality of from 3 to 5, such as 3.0 to 4.0 or 3.3 to 3.7, and/or a weighted average hydroxyl number of from 300 to 500 mg KOH/g, such as 350 to 450 mg KOH/g. In certain embodiments, the polyol blend is present in the polyurethane foam-forming composition in an amount of at least 50% by weight, such as 50 to 90% by weight or 60 to 80% by weight, based on the total weight of the isocyanate-reactive composition (or, in the case of the polyurethane foam-forming composition, based on polyurethane foam-forming composition except for the weight of the polyisocyanate).

As earlier indicated, one aspect of the inventions of this specification is that the polyol blend of the isocyanate-reactive compositions has a content of —C₂H₄O— units of 2 to 8% by weight, based on total weight of the polyol blend. In some implementation, the polyol blend has a content of —C₂H₄O— units of 3% to 6% by weight or 4% to 5% by weight, based on total weight of the polyol blend. Further, in some embodiments, the polyurethane foam-forming compositions of this specification have a content of —C₂H₄O— units of 1 to 5% by weight, based on total weight of the polyurethane foam-forming composition. In some implementation, the polyol blend has a content of —C₂H₄O— units of 1 to 3% by weight or 1.5 to 2.5% by weight, based on total weight of the polyurethane foam-forming composition.

In some implementations, the sum of the amount of the previously described first hydroxyl-initiated polyether polyol, second hydroxyl-initiated polyether polyol, aromatic amine-initiated polyether polyol, and alkanolamine-initiated polyether polyol is at least 90% by weight, such as at least 95% by weight, at least 98% by weight, or, in some cases, 100% by weight, based on the total weight of the polyol blend.

Further, in some implementations, the polyol blend does not include any filled polyol. As will be appreciated, a “filled polyol” is a dispersion of polymer particles in a base polyol. Examples of filled polyols, any or all of which are excluded from use in the some implementations of the polyol blends employed in the inventions disclosed herein, are “polymer polyols”, in which the polymer particles comprise a polymer comprising the free radical polymerization reaction product of an ethylenically unsaturated compound, “PIPA polyols”, in which the polymer particles comprise a polyisocyanate polyaddition polymer comprising the reaction product of a polymerizable composition comprising an isocyanate and an alkanolamine, and “PHD polyols” in which the polymer particles comprise a polyhydrazodiconamide comprising the reaction product of a reaction mixture comprising an isocyanate and a diamine and/or a hydrazine.

As indicated, the polyurethane foam-forming compositions of this specification further comprises a physical blowing agent composition comprising a HCFO. Suitable HCFOs include 1-chloro-3,3,3-trifluoropropene (HCFO-1233zd, E and/or Z isomers), 2-chloro-3,3,3-trifluoropropene (HCFO-1233xf), HCFO1223, 1,2-dichloro-1,2-difluoroethene (E and/or Z isomers), 3,3-dichloro-3-fluoropropene, 2-chloro-1,1,1,4,4,4-hexafluorobutene-2 (E and/or Z isomers), 2-chloro-1,1,1,3,4,4,4-heptafluorobutene-2 (E and/or Z isomers). In some implementations, the boiling point, at atmospheric pressure, of the HCFO is at least −25° C., at least −20° C., or, in some cases, at least −19° C., and 40° C. or less, such as 35° C. or less, or, in some cases 33° C. or less. The HCFO may have a boiling point, at atmospheric pressure, of, for example, −25° C. to 40° C., or −20° C. to 35° C., or −19° C. to 33° C.

The HCFO is present in an amount of 5% to 25% by weight, based on the total weight of the isocyanate-reactive composition (or, in the case of the polyurethane foam-forming composition, based on total weight of the polyurethane foam-forming composition except for the weight of the polyisocyanate). In some implementations, the HCFO is utilized in an amount of 10% to 20% by weight, 10 to 15% by weight or 12 to 14% by weight, based on the total weight of the isocyanate-reactive composition (or, in the case of the polyurethane foam-forming composition, based on total weight of the polyurethane foam-forming composition except for the weight of the polyisocyanate).

If desired, the isocyanate-reactive composition may include one or more other physical blowing agents, such as other halogenated blowing agents, such as CFCs, HCFCs, HFCs, other HFOs (aside from HCFO) and/or hydrocarbon blowing agents, such as butane, n-pentane, cyclopentane, hexane, and/or isopentane (i.e., 2-methylbutane). In other embodiments, however, the isocyanate-reactive composition is substantially or, in some cases, completely free, of such other physical blowing agents. Therefore, the HCFO is present in amount of at least 80% by weight, such as at least 90% by weight, at least 95% by weight, at least 99% by weight or, in some cases 100% by weight, based on the total weight of the physical blowing agent in the blowing agent composition.

The polyurethane foam-forming compositions of this specification also include water, which acts as a carbon dioxide generating chemical blowing agent. Specifically, water is utilized in an amount of at least 1% by weight, such as 1.0% to 5.0% by weight, 1.0 to 3.0% by weight, 2.0 to 3.0% by weight, or 2.1 to 2.5% by weight, based on the total weight of the isocyanate-reactive composition (or, in the case of the polyurethane foam-forming composition, based on total weight of the polyurethane foam-forming composition except for the weight of the polyisocyanate).

In certain implementations, the physical blowing agent composition and the water are present in a relative ratio, by weight, of at least 4:1, such as 4:1 to 50:1, 5:1 to 50:1, 5:1 to 20:1, 5:1 to 9:1 or 5:1 to 6:1.

The polyurethane foam-forming composition also optionally comprises a surfactant. Suitable surfactants include, for example, organosilicon compounds, such as polysiloxane-polyalkyene-block copolymers, such as a polyether-modified polysiloxane. Other possible surfactants include polyethylene glycol ethers of long chain alcohols, tertiary amine or alkanolamine salts of long chain alkyl acid sulfate esters, alkylsulfonic esters, or alkylarylsulfonic acids. Such surfactants are employed in amounts sufficient to stabilize the foaming reaction mixture against collapse and the formation of large and uneven cells. In some implementations, surfactant is utilized in an amount of 0.2 to 5.0% by weight, such as 1 to 3% by weight, based on the total weight of the isocyanate-reactive composition (or, in the case of the polyurethane foam-forming composition, based on total weight of the polyurethane foam-forming composition except for the weight of the polyisocyanate).

The polyurethane foam-forming compositions of this specification also optionally comprises a catalyst, such as a tertiary amine, tertiary phosphine, a metal chelate, an acid metal salt, a strong base, a metal alcoholate and/or phenolate, a metal salt of an organic acid, or a combination thereof. In some implementations, the catalyst comprises an organotin catalyst and/or tertiary amine catalyst. For example, in some cases, a combination of at least one “blowing” catalyst, which strongly promotes the reaction of an isocyanate group with a water molecule to form carbon dioxide, and either at least one “gelling” catalyst, which strongly promotes the reaction of an alcohol group with an isocyanate to form the urethane, or at least one trimerization catalyst, may be used.

In some embodiments, the catalyst comprises a tertiary amine, an organometallic compound, or a combination thereof. Specific examples of suitable tertiary amine catalysts include: pentamethyldiethylenetriamine, N,N-dimethylcyclohexylamine, N,N′,N″-tris(3-dimethylaminopropyl-)hexahydrotriazine, tetramethylethylenediamine, tetraethylene diamine, benzyldimethylamine or a combination thereof. In certain embodiments, the tertiary amine catalyst includes pentamethyldiethylenetriamine, N,N′,N″-dimethylaminopropyl-hexahydrotriazine, N,N-dimethylcyclohexylamine, or a combination thereof. Specific examples of suitable organometallic catalysts include dibutyltin dilaurate, dibutyltin diacetate, stannous octoate, potassium octoate, potassium acetate, potassium 2-ethylhexanoate, or a combination thereof.

More specifically, in some cases, the catalyst comprises a tertiary amine comprising a morpholine, an imidazole, or a combination thereof. Further, in some implementations, the tertiary amine catalyst composition comprises: (i) 80% to 100%, 80% to 99% by weight, 90 to 100% by weight, or, in some cases, 95 to 100% by weight, based on the total weight of the tertiary amine catalyst composition, of a morpholine; and (ii) up to 20% by weight, up to 10% by weight, or, in some cases, up to 5% by weight or up to 3% by weight, based on the total weight of the tertiary amine catalyst composition, of an imidazole.

Suitable morpholine catalysts include, for example, dimorpholinodiethylether, dimorpholinodimethylether, N-ethylmorpholine, and N-methylmorpholine. Suitable imidazole catalysts include, for example, imidazole, n-methylimidazole, and 1,2-dimethylimidazole. In some embodiments, the morpholine catalyst comprises a mixture of two or more morpholine catalyst, such as a mixture of dimorpholinodiethylether and N-methylmorpholine wherein, for example, the dimorpholinodiethylether is utilized in an amount of 30 to 80% by weight, such as 40 to 80% by weight, and N-methylmorpholine is utilized in an amount of 20 to 70% by weight, such as 20 to 60% by weight, based on the total weight of morpholine catalyst utilized.

In certain embodiments, the tertiary amine catalyst composition does not include an acid-blocked amine catalyst. In certain embodiments, the isocyanate-reactive composition does not include a metal catalyst and/or any other catalyst that is not a tertiary amine catalyst.

In certain embodiments, the total amount of tertiary amine catalyst utilized in the isocyanate-reactive composition is 1 to 5% by weight, such as 2.0 to 4.0% or 2.0 to 3.0% by weight, based on the total weight of the isocyanate-reactive composition.

Additional materials which may optionally be included in the foam-forming compositions of the present invention include: pigments, colorants, fillers, antioxidants, flame retardants, and stabilizers. Exemplary flame retardants useful in the foam-forming composition of the present invention include, but are not limited to, reactive bromine based compounds and chlorinated phosphate esters, including but not limited to, tri(2-chloroethyl)phosphate (TECP), tri(1,3-dichloro-2-propyl)phosphate, tri(1-chloro-2-propyl)phosphate (TCPP) and dimethyl propyl phosphate (DMPP).

This specification also relates to isocyanate-reactive composition suitable for use in preparing the previously described polyurethane foam-forming composition. These isocyanate-reactive compositions include the polyol blend and blowing agent composition described above. Such isocyanate-reactive composition may also include one or more of the other components described above, with the exception of the polyisocyanate. Thus, in some embodiments, the isocyanate-reactive composition further comprises the previously described surfactant, catalyst, or both surfactant and catalyst.

This specification is also directed to processes for producing rigid polyurethane foams. In such processes, a polyisocyanate is reacted with an isocyanate-reactive composition comprising the polyol blend. In some implementations, the isocyanate functional component and the polyol blend are mixed at an isocyanate index of from 0.9 to 1.5, such as 1.0 to less than 1.5 or 1.0 to 1.1.

The polyol blend is reacted with a polyisocyanate in the presence of the blowing agent composition, the catalyst composition, a surfactant and any other optional ingredients. The rigid foams may be prepared by blending all of the polyurethane foam-forming composition components, except for the polyisocyanate, together in a phase stable mixture, and then mixing this mixture in the proper ratio with the polyisocyanate. Alternatively, one or more of the components, such as the surfactant, may be combined with the polyisocyanate prior to mixing it with the polyol blend. Other possible implementations would include adding one or more of the components as a separate stream, together with the polyol blend and polyisocyanate. As used herein, the term phase stable means that the composition does not visibly separate when stored for 60 days at about 70° F. (or 21° C.).

Many foam machines are designed to condition and mix only two components in the proper ratio. For use of these machines, a premix of all the components except the polyisocyanate can be advantageously employed. According to the two-component method (component A: polyisocyanate; and component B: isocyanate-reactive composition which typically includes the polyol blend, blowing agent, water, catalyst and surfactant), the components may be mixed in the proper ratio at a temperature of 5 to 50° C., such as 15 to 35° C., injected or poured into a mold having the temperature controlled to within a range of from 20 to 70° C., such as 35 to 60° C. The mixture then expands to fill the cavity with the rigid polyurethane foam. This simplifies the metering and mixing of the reacting components which form the foam-forming mixture but requires that the isocyanate reactive composition be phase stable.

Alternatively, the rigid polyurethane foams may also be prepared by the so-called “quasi prepolymer” method. In this method, a portion of the polyol component is reacted in the absence of the urethane-forming catalysts with the polyisocyanate component in proportion so as to provide from 10 percent to 35 percent of free isocyanate groups in the reaction product based on the prepolymer. To prepare foam, the remaining portion of the polyol is added, and the components are allowed to react together in the presence of the blowing agent and other appropriate additives such as the catalysts, and surfactants. Other additives may be added to either the isocyanate prepolymer or remaining polyol or both prior to the mixing of the components, whereby at the end of the reaction, rigid foam is provided.

Furthermore, the rigid foam can be prepared in a batch or continuous process by the one-shot or quasi-prepolymer methods using any well-known foaming apparatus. The rigid foam may be produced in the form of slab stock, moldings, cavity fillings, sprayed foam, frothed foam or laminates with other materials such as hardboard, plasterboard, plastics, paper or metal as facer substrates.

For closed-cell insulating foams, the object is to retain the blowing agent in the cells to maintain a low thermal conductivity of the insulating material, i.e., the rigid foam. Thus, high closed-cell content in the foam is desirable. In some implementations, the rigid foams produced according to implementations of this specification have a closed-cell content of more than 80 percent, more than 85 percent, or more than 88 percent, as measured according to ASTM D6226-15. Furthermore, the thermal conductivity of foams produced according to various implementations of the present specification indicates that the foams have acceptable insulating properties, i.e., the foams have a thermal conductivity measured at 35° F. (2° C.) of less than 0.130 BTU-in/h-ft²-° F. and measured at 75° F. (24° C.) of less than 0.150 BTU-in/h-ft²-° F. for foam from the core of 2 or 3-inch thick panels, as measured according to ASTM C518-15.

This specification also relates to the use of the rigid foams described herein for thermal insulation. That is, the rigid foams of the present specification may find use as an insulating material in refrigeration apparatuses. These rigid foams can be used, for example, as an intermediate layer in composite elements or for filling hollow spaces of refrigerators, freezers, or refrigerated trailers. These foams may also find use in the construction industry or for thermal insulation of long-distance heating pipes and containers.

As such, the present invention also provides a composite article comprising rigid foam as disclosed herein sandwiched between one or more facer substrates. In certain implementations, the facer substrate may be plastic (such a polypropylene resin reinforced with continuous bi-directional glass fibers or a fiberglass reinforced polyester copolymer), paper, wood, or metal. For example, in certain implementations, the composite article may be a refrigeration apparatus such as a refrigerator, freezer, or cooler with an exterior metal shell and interior plastic liner. In certain implementations, the refrigeration apparatus may be a trailer, and the composite article may include the foams produced according to the present invention in sandwich composites for trailer floors or sidewalls.

It has been found, surprisingly, that the particular polyurethane foam-forming compositions described herein are capable, when formulated with appropriate additives (surfactants, catalysts, etc.), of producing rigid polyurethane foams with similar thermal insulation properties (as determined by K-factor measurements) while utilizing a significantly (around 15% by weight) reduced amount of costly HCFO physical blowing agent, while still retaining other important foam properties and processing characteristics, such as dimensional stability, compressive strength, flow, reactivity and de-mold characteristics, and while providing an isocyanate-reactive composition that is phase stable. As used herein, the term “phase stable” means that the isocyanate-reactive composition does not visually separate when stored for 60 days at about 70° F. (or 21° C.).

Various aspects of the subject matter described herein are set out in the following numbered clauses:

Clause 1. An isocyanate-reactive composition comprising: (a) a polyol blend comprising: (1) 30% to 98% by weight, based on total weight of the polyol blend, of a first hydroxyl-initiated polyether polyol having a functionality of 1.5 to less than 4.0 and an OH number of 200 to 600 mg KOH/g; (2) 1 to 40% by weight, based on total weight of the polyol blend, of a second hydroxyl-initiated polyether polyol having a functionality of 4.0 to 8 and an OH number of 300 to 600 mg KOH/g; and (3) 1 to 30% by weight, based on total weight of the polyol blend, of an aromatic amine-initiated polyether polyol having a functionality of at least 2.5 and an OH number of 200 to 600 mg KOH/g, wherein the polyol blend has a content of —C₂H₄O— units of 2 to 8% by weight, based on the total weight of the polyol blend; and (b) a blowing agent composition comprising: (1) a physical blowing agent and (2) water, in which (i) the water is present in an amount of at least 1% by weight, based on the total weight of the isocyanate-reactive composition, (ii) the physical blowing agent comprises a HFCO that is present in an amount of 5 to 25% by weight, based on total weight of the isocyanate-reactive composition, and in an amount of at least 80% by weight, based on total weight of the physical blowing agent present in the blowing agent composition; and (iii) the physical blowing agent and the water are present in a relative ratio, by weight, of at least 4:1.

Clause 2. The isocyanate-reactive composition of clause 1, wherein the first hydroxyl-initiated polyether polyol has a functionality of 1.5 to 3.5, 2.5 to 3.5, or 2.8 to 3.2, and/or an OH number of 300 to 500 mg KOH/g, 350 to 450 mg KOH/g, or 350 to 400 mg KOH/g.

Clause 3. The isocyanate-reactive composition of clause 1 or clause 2, wherein the second such polyether polyol has a functionality of 4.0 to 8.0, 4.5 to 6.5, 5.0 to 6.0, or 5.3 to 5.7, and an OH number of 300 to 600 mg KOH/g, 300 to 500 mg KOH/g, 350 to 450 mg KOH/g, or 350 to 400 mg KOH/g.

Clause 4. The isocyanate-reactive composition of one of clause 1 to clause 3, wherein the first hydroxyl-initiated polyether polyol and the second hydroxyl-initiated polyether polyol are an addition product of alkylene oxide onto one or more OH-functional initiators, wherein the addition reaction optionally occurs in the presence of a suitable catalyst, such as a basic catalyst or a DMC catalyst.

Clause 5. The isocyanate-reactive composition of clause 4, wherein the OH-functional initiator comprises water, ethylene glycol, diethylene glycol, butyl diglycol, glycerol, diethylene glycol, trimethylolpropane, propylene glycol, pentaerythritol, sorbitol, sucrose, triethanolamine, 1,4-butanediol, 1,6-hexanediol, a low molecular weight hydroxyl-containing ester of such polyols with dicarboxylic acids, or any mixture of any two or more thereof.

Clause 6. The isocyanate-reactive composition of clause 4 or clause 5, wherein the OH-functional initiator is present in an amount of more than 50% by weight, at least 80% by weight, at least 90% by weight, or 100% by weight, based on the total weight of H-functional initiator used to produce the first hydroxyl-initiated polyether polyol and/or the second hydroxyl-initiated polyether polyol.

Clause 7. The isocyanate-reactive composition of one of clause 4 to clause 6, wherein propylene oxide is present in an amount of more than 50% by weight, at least 60% by weight, at least 70% by weight, at least 80% by weight, at least 90% by weight, or 100% by weight, based on the total weight of alkylene oxide used to prepare the first hydroxyl-initiated polyether polyol and/or the second hydroxyl-initiated polyether polyol.

Clause 8. The isocyanate-reactive composition of one of clause 4 to clause 7, wherein ethylene oxide is present in an amount of less than 50% by weight, no more than 40% by weight, no more than 30% by weight, no more than 20% by weight, no more than 10% by weight, no more than 5% by weight, no more than 1% by weight, or 0% by weight, based on the total weight of alkylene oxide used to prepare the first hydroxyl-initiated polyether polyol and/or the second hydroxyl-initiated polyether polyol.

Clause 9. The isocyanate-reactive composition of one of clause 4 to clause 8, wherein propylene oxide is present in an amount of at least 80% by weight, at least 90% by weight, or 100% by weight, based on the total weight of alkylene oxide used to prepare the first hydroxyl-initiated polyether polyol and ethylene oxide is present in an amount of no more than 20% by weight, no more than 10% by weight, no more than 5% by weight, no more than 1% by weight, or 0% by weight, based on the total weight of alkylene oxide used to prepare the first hydroxyl-initiated polyether polyol.

Clause 10. The isocyanate-reactive composition of one of clause 4 to clause 9, wherein propylene oxide is present in an amount of 60 to 90% by weight, 60 to 80% by weight, or 65 to 75% by weight, based on the total weight of alkylene oxide used to prepare the second hydroxyl-initiated polyether polyol and ethylene oxide is used in an amount of 10% to 40% by weight, 20 to 40% by weight, or 25 to 35% by weight, based on the total weight of alkylene oxide used to prepare the second hydroxyl-initiated polyether polyol.

Clause 11. The isocyanate-reactive composition of one of clause 1 to clause 10, wherein the first hydroxyl-initiated polyether polyol is present in an amount of 30% to 80% by weight, 30% to 70% by weight, 40% to 60% by weight, or 45% to 55% by weight, based on total weight of the polyol blend.

Clause 12. The isocyanate-reactive composition of one of clause 1 to clause 11, wherein the second hydroxyl-initiated polyether polyol is present in an amount of 10% by to 40% by weight, or 20% to 30% by weight, based on total weight of the polyol blend.

Clause 13. The isocyanate-reactive composition of one of clause 1 to clause 12, wherein the first hydroxyl-initiated polyether polyol has a content of —C₂H₄O— units of less than 10% by weight, less than 5% by weight, less than 2% by weight, or 0% by weight, based on total weight of the first hydroxyl-initiated polyether polyol.

Clause 14. The isocyanate-reactive composition of one of clause 1 to clause 13, wherein the second hydroxyl-initiated polyether polyol has a content of —C₂H₄O— units of 10% to 50% by weight, such as 10% to 40% by weight, 10% to 30% by weight, or 15% to 25% by weight, based on total weight of the second hydroxyl-initiated polyether polyol.

Clause 15. The isocyanate-reactive composition of one of clause 1 to clause 14, wherein the aromatic amine-initiated polyether polyol is a reaction product of an H-functional initiator comprising an aromatic amine with alkylene oxide, such as where the aromatic amine comprises o-TDA.

Clause 16. The isocyanate-reactive composition of clause 15, wherein the aromatic amine is present in an amount of more than 50% by weight, at least 80% by weight, at least 90% by weight, or 100% by weight, based on the total weight of H-functional initiator used to produce the aromatic amine-initiated polyether polyol.

Clause 17. The isocyanate-reactive composition of clause 15 or clause 16, wherein propylene oxide is present in an amount of more than 50% by weight, at least 80% by weight, at least 90% by weight, or 100% by weight, based on the total weight of alkylene oxide used to prepare the aromatic amine-initiated polyether polyol, and ethylene oxide is present in an amount of no more than 10% by weight, no more than 5% by weight, no more than 1% by weight, or 0% by weight, based on the total weight of alkylene oxide used to prepare the aromatic amine-initiated polyether polyol.

Clause 18. The isocyanate-reactive composition of one of clause 1 to clause 17, wherein the aromatic amine-initiated polyether polyol has an OH number of 300 to 500 mg KOH/g, 350 to 450 mg KOH/g or 380 to 420 mg KOH/g, and/or a functionality of 2.5 to 4.5, 3.5 to 4.5, 3.8 to 4.2 or 4.0.

Clause 19. The isocyanate-reactive composition of one of clause 1 to clause 18, wherein the aromatic amine-initiated polyether polyol has a content of —C₂H₄O— units of less than 10% by weight, less than 5% by weight, less than 2% by weight, or 0% by weight, based on total weight of the aromatic amine-initiated polyether polyol.

Clause 20. The isocyanate-reactive composition of one of clause 1 to clause 19, wherein the aromatic amine-initiated polyether polyol is present in an amount of 1% to 25% by weight, 10% to 20% by weight, or 10% to 15% by weight, based on the total weight of the polyol blend.

Clause 21. The isocyanate-reactive composition of one of clause 1 to clause 20, wherein the polyol blend further comprises an aromatic polyester polyol.

Clause 22. The isocyanate-reactive composition of clause 21, wherein the aromatic polyester polyol has an OH number of 150 to 410 mg KOH/g, 150 to 360 mg KOH/g, 200 to 335 mg KOH/g, or 200 to 250 mg KOH/g, and a functionality of 1.5 to 3 or 1.9 to 2.5.

Clause 23. The isocyanate-reactive composition of clause 20 or clause 21, wherein the aromatic polyester polyol has a content of —C₂H₄O— units of less than 50% by weight, based on total weight of the aromatic polyester polyol.

Clause 24. The isocyanate-reactive composition of one of clause 21 to clause 23, wherein the aromatic polyester polyol is present in an amount of up to 10% by weight, 1 to 10% by weight, or 5 to 10% by weight, based on total weight of the polyol blend.

Clause 25. The isocyanate-reactive composition of one of clause 1 to clause 24, wherein the polyol blend further comprises an alkanolamine-initiated polyether polyol comprising a reaction product of an alkylene oxide with an H-functional initiator comprising an alkanolamine.

Clause 26. The isocyanate-reactive composition of clause 25, wherein the alkanolamine is represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms, wherein the dialkylene ether radical is represented by the formula:

R—O—R—

where each R represents a hydrocarbon radical having 2 to 3 carbon atoms, such as where the alkanolamine comprises monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, or a mixture of any two or more thereof.

Clause 27. The isocyanate-reactive composition of clause 24 or clause 25, wherein the alkanolamine is present in an amount of more than 50% by weight, at least 80% by weight, at least 90% by weight, or 100% by weight, based on the total weight of H-functional initiator used to produce the alkanolamine-initiated polyether polyol

Clause 28. The isocyanate-reactive composition of one of clause 25 to clause 27, wherein the propylene oxide is present in an amount of more than 50% by weight, at least 80% by weight, at least 90% by weight, or 100% by weight, based on the total weight of alkylene oxide used to prepare the alkanolamine-initiated polyether polyol, and ethylene oxide is present in an amount of no more than 10% by weight, no more than 5% by weight, no more than 1% by weight, or 0% by weight, based on the total weight of alkylene oxide used to prepare the alkanolamine-initiated polyether polyol

Clause 29. The isocyanate-reactive composition of one of clause 25 to clause 28, wherein the alkanolamine-initiated polyether polyol has an OH number of more than 500 mg KOH/g, more than 500 to 900 mg KOH/g, 600 to 800 mg KOH/g, or 680 to 720 mg KOH/g, and a functionality of 2.5 to 4 or 2.5 to 3.5.

Clause 30. The isocyanate-reactive composition of one of clause 25 to clause 29, wherein the alkanolamine-initiated polyether polyol is present in an amount of 0.1 to 10% by weight, 1% to 10% by weight, or 5% to 10% by weight, based upon the total weight of the polyol blend.

Clause 31. The isocyanate-reactive composition of one of clause 25 to clause 30, wherein the alkanolamine-initiated polyether polyol has a content of —C₂H₄O— units of less than 10% by weight, less than 5% by weight, less than 2% by weight, or 0% by weight, based on total weight of the alkanolamine-initiated polyether polyol.

Clause 32. The isocyanate-reactive composition of one of clause 1 to clause 31, wherein the first hydroxyl-initiated polyether polyol and the second hydroxyl-initiated polyether polyol are present in a weight ratio of 1:5 to 5:1, 1:1 to 5:1, 1:1 to 3:1 or 1.5:1 to 2.5:1.

Clause 33. The isocyanate-reactive composition of one of clause 1 to clause 32, wherein the first hydroxyl-initiated polyether polyol and the aromatic amine-initiated polyether polyol are present in a weight ratio of 1:1 to 5:1, 1:1 to 4:1, 1:1 to 3:1, or 2:1 to 3:1.

Clause 34. The isocyanate-reactive composition of one of clause 1 to clause 33, wherein the second hydroxyl-initiated polyether polyol and the aromatic amine-initiated polyether polyol are present in a weight ratio of 1:2 to 2:1, 1:1 to 2:1, or 1:1 to 1.5:1.

Clause 35. The isocyanate-reactive composition of one of clause 1 to clause 34, wherein the polyol blend has a weighted average functionality of 3 to 5, 3.0 to 4.0, or 3.3 to 3.7, and/or a weighted average hydroxyl number of 300 to 500 mg KOH/g or 350 to 450 mg KOH/g.

Clause 36. The isocyanate-reactive composition of one of clause 1 to clause 35, wherein the polyol blend is present in an amount of at least 50% by weight, 50 to 90% by weight or 60 to 80% by weight, based on the total weight of the isocyanate-reactive composition.

Clause 37. The isocyanate-reactive composition of one of clause 1 to clause 36, wherein the polyol blend has a content of —C₂H₄O— units of 3% to 6% by weight or 4% to 5% by weight, based on total weight of the polyol blend.

Clause 38. The isocyanate-reactive composition of one of clause 1 to clause 37, wherein the sum of the amount of the first hydroxyl-initiated polyether polyol, second hydroxyl-initiated polyether polyol, aromatic amine-initiated polyether polyol, and alkanolamine-initiated polyether polyol is at least 90% by weight, at least 95% by weight, at least 98% by weight, or 100% by weight, based on the total weight of the polyol blend.

Clause 39. The isocyanate-reactive composition of one of clause 1 to clause 38, wherein the polyol blend does not include any filled polyol.

Clause 40. The isocyanate-reactive composition of one of clause 1 to clause 39, wherein the HCFO comprises 1-chloro-3,3,3-trifluoropropene, 2-chloro-3,3,3-trifluoropropene, 1,2-dichloro-1,2-difluoroethene, 3,3-dichloro-3-fluoropropene, 2-chloro-1,1,1,4,4,4-hexafluorobutene-2, 2-chloro-1,1,1,3,4,4,4-heptafluorobutene-2, or a mixture of any two or more thereof.

Clause 41. The isocyanate-reactive composition of one of clause 1 to clause 40, wherein the HCFO is present in an amount of 10% to 20% by weight, 10 to 15% by weight or 12 to 14% by weight, based on the total weight of the isocyanate-reactive composition.

Clause 42. The isocyanate-reactive composition of one of clause 1 to clause 41, wherein the HCFO is present in amount of at least 80% by weight, at least 90% by weight, at least 95% by weight, at least 99% by weight or 100% by weight, based on the total weight of the physical blowing agent in the blowing agent composition.

Clause 43. The isocyanate-reactive composition of one of clause 1 to clause 42, wherein the water is present in an amount of 1.0% to 5.0% by weight, 1.0% to 3.0% by weight, 2.0 to 3.0% by weight, or 2.1 to 2.5% by weight, based on the total weight of the isocyanate-reactive composition.

Clause 44. The isocyanate-reactive composition of one of clause 1 to clause 43, wherein the physical blowing agent composition and the water are present in a relative ratio, by weight, of 4:1 to 50:1, 5:1 to 50:1, 5:1 to 20:1, 5:1 to 9:1 or 5:1 to 6:1.

Clause 45. The isocyanate-reactive composition of one of clause 1 to clause 44, further comprising a tertiary amine comprising a morpholine, an imidazole, or a combination thereof, such as where the tertiary amine comprises: (i) 80% to 100%, 80% to 99% by weight, 90 to 100% by weight, or 95 to 100% by weight, based on the total weight of the tertiary amine catalyst composition, of a morpholine; and (ii) up to 20% by weight, up to 10% by weight, or up to 5% by weight or up to 3% by weight, based on the total weight of the tertiary amine catalyst composition, of an imidazole.

Clause 46. The isocyanate-reactive composition of clause 45, wherein the morpholine comprises dimorpholinodiethylether, dimorpholinodimethylether, N-ethylmorpholine, N-methylmorpholine, or a mixture of any two or more thereof, and the imidazole comprises imidazole, n-methylimidazole, 1,2-dimethylimidazole, or a mixture of any two or more thereof, such as a mixture of dimorpholinodiethylether and N-methylmorpholine wherein the dimorpholinodiethylether is utilized in an amount of 30 to 80% by weight or 40 to 80% by weight, and N-methylmorpholine is utilized in an amount of 20 to 70% by weight or 20 to 60% by weight, based on the total weight of morpholine.

Clause 47. The isocyanate-reactive composition of clause 45 or clause 46, wherein the tertiary amine is present in an amount of 1 to 5% by weight, 2.0 to 4.0%, or 2.0 to 3.0% by weight, based on the total weight of the isocyanate-reactive composition.

Clause 48. The isocyanate-reactive composition of one of clause 1 to clause 47, wherein the isocyanate-reactive composition is phase stable.

Clause 49. A process for producing a rigid polyurethane foam comprising reacting a polyisocyanate is reacted with the isocyanate-reactive composition of one of clause 1 to clause 47 at an isocyanate index of 0.9 to 1.5, 1.0 to less than 1.5 or 1.0 to 1.1.

Clause 50. A polyurethane foam-forming composition comprising: (a) a polyol blend comprising: (1) 30% to 98% by weight, based on total weight of the polyol blend, of a hydroxyl-initiated polyether polyol having a functionality of 1.5 to less than 4.0 and an OH number of 200 to 600 mg KOH/g; (2) 1 to 40% by weight, based on total weight of the polyol blend, of a hydroxyl-initiated polyether polyol having a functionality of 4.0 to 8 and an OH number of 300 to 600 mg KOH/g; and (3) 1 to 30% by weight, based on total weight of the polyol blend, of an aromatic amine-initiated polyether polyol having a functionality of at least 2.5 and an OH number of 200 to 600 mg KOH/g. The polyol blend has a content of —C₂H₄O— units of 1 to 5% by weight, based on total weight of the polyurethane foam-forming composition; (b) a blowing agent composition comprising: (1) a physical blowing agent and (2) water, in which (i) the water is present in an amount of at least 1% by weight, based on the total weight of the polyurethane foam-forming composition except for the weight of the polyisocyanate, (ii) the physical blowing agent comprises a hydrochlorofluoroolefin that is present in an amount of 5 to 25% by weight, based on total weight of the polyurethane foam-forming composition except for the weight of the polyisocyanate, and in an amount of at least 80% by weight, based on total weight of the physical blowing agent present in the blowing agent composition; and (iii) the physical blowing agent and the water are present in a relative ratio, by weight, of at least 4:1; and (c) a polyisocyanate present in an amount sufficient to provide an isocyanate index of 0.9 to 1.5.

Clause 51. The polyurethane foam-forming composition of clause 50, wherein the first hydroxyl-initiated polyether polyol has a functionality of 1.5 to 3.5, 2.5 to 3.5, or 2.8 to 3.2, and/or an OH number of 300 to 500 mg KOH/g, 350 to 450 mg KOH/g, or 350 to 400 mg KOH/g.

Clause 52. The polyurethane foam-forming composition of clause 50 or clause 51, wherein the second such polyether polyol has a functionality of 4.0 to 8.0, 4.5 to 6.5, 5.0 to 6.0, or 5.3 to 5.7, and an OH number of 300 to 600 mg KOH/g, 300 to 500 mg KOH/g, 350 to 450 mg KOH/g, or 350 to 400 mg KOH/g.

Clause 53. The polyurethane foam-forming composition of one of clause 50 to clause 52, wherein the first hydroxyl-initiated polyether polyol and the second hydroxyl-initiated polyether polyol are an addition product of alkylene oxide onto one or more OH-functional initiators, wherein the addition reaction optionally occurs in the presence of a suitable catalyst, such as a basic catalyst or a DMC catalyst.

Clause 54. The polyurethane foam-forming composition of clause 53, wherein the OH-functional initiator comprises water, ethylene glycol, diethylene glycol, butyl diglycol, glycerol, diethylene glycol, trimethylolpropane, propylene glycol, pentaerythritol, sorbitol, sucrose, triethanolamine, 1,4-butanediol, 1,6-hexanediol, a low molecular weight hydroxyl-containing ester of such polyols with dicarboxylic acids, or any mixture of any two or more thereof.

Clause 55. The polyurethane foam-forming composition of clause 53 or clause 54, wherein the OH-functional initiator is present in an amount of more than 50% by weight, at least 80% by weight, at least 90% by weight, or 100% by weight, based on the total weight of H-functional initiator used to produce the first hydroxyl-initiated polyether polyol and/or the second hydroxyl-initiated polyether polyol.

Clause 56. The polyurethane foam-forming composition of one of clause 53 to clause 55, wherein propylene oxide is present in an amount of more than 50% by weight, at least 60% by weight, at least 70% by weight, at least 80% by weight, at least 90% by weight, or 100% by weight, based on the total weight of alkylene oxide used to prepare the first hydroxyl-initiated polyether polyol and/or the second hydroxyl-initiated polyether polyol.

Clause 57. The polyurethane foam-forming composition of one of clause 53 to clause 56, wherein ethylene oxide is present in an amount of less than 50% by weight, no more than 40% by weight, no more than 30% by weight, no more than 20% by weight, no more than 10% by weight, no more than 5% by weight, no more than 1% by weight, or 0% by weight, based on the total weight of alkylene oxide used to prepare the first hydroxyl-initiated polyether polyol and/or the second hydroxyl-initiated polyether polyol.

Clause 58. The polyurethane foam-forming composition of one of clause 53 to clause 57, wherein propylene oxide is present in an amount of at least 80% by weight, at least 90% by weight, or 100% by weight, based on the total weight of alkylene oxide used to prepare the first hydroxyl-initiated polyether polyol and ethylene oxide is present in an amount of no more than 20% by weight, no more than 10% by weight, no more than 5% by weight, no more than 1% by weight, or 0% by weight, based on the total weight of alkylene oxide used to prepare the first hydroxyl-initiated polyether polyol.

Clause 59. The polyurethane foam-forming composition of one of clause 53 to clause 58, wherein propylene oxide is present in an amount of 60 to 90% by weight, 60 to 80% by weight, or 65 to 75% by weight, based on the total weight of alkylene oxide used to prepare the second hydroxyl-initiated polyether polyol and ethylene oxide is used in an amount of 10% to 40% by weight, 20 to 40% by weight, or 25 to 35% by weight, based on the total weight of alkylene oxide used to prepare the second hydroxyl-initiated polyether polyol.

Clause 60. The polyurethane foam-forming composition of one of clause 50 to clause 59, wherein the first hydroxyl-initiated polyether polyol is present in an amount of 30% to 80% by weight, 30% to 70% by weight, 40% to 60% by weight, or 45% to 55% by weight, based on total weight of the polyol blend.

Clause 61. The polyurethane foam-forming composition of one of clause 50 to clause 60, wherein the second hydroxyl-initiated polyether polyol is present in an amount of 10% by to 40% by weight, or 20% to 30% by weight, based on total weight of the polyol blend.

Clause 62. The polyurethane foam-forming composition of one of clause 50 to clause 61, wherein the first hydroxyl-initiated polyether polyol has a content of —C₂H₄O— units of less than 10% by weight, less than 5% by weight, less than 2% by weight, or 0% by weight, based on total weight of the first hydroxyl-initiated polyether polyol.

Clause 63. The polyurethane foam-forming composition of one of clause 50 to clause 62, wherein the second hydroxyl-initiated polyether polyol has a content of —C₂H₄O— units of 10% to 50% by weight, such as 10% to 40% by weight, 10% to 30% by weight, or 15% to 25% by weight, based on total weight of the second hydroxyl-initiated polyether polyol.

Clause 64. The polyurethane foam-forming composition of one of clause 50 to clause 63, wherein the aromatic amine-initiated polyether polyol is a reaction product of an H-functional initiator comprising an aromatic amine with alkylene oxide, such as where the aromatic amine comprises o-TDA.

Clause 65. The polyurethane foam-forming composition of clause 64, wherein the aromatic amine is present in an amount of more than 50% by weight, at least 80% by weight, at least 90% by weight, or 100% by weight, based on the total weight of H-functional initiator used to produce the aromatic amine-initiated polyether polyol.

Clause 66. The polyurethane foam-forming composition of clause 64 or clause 65, wherein propylene oxide is present in an amount of more than 50% by weight, at least 80% by weight, at least 90% by weight, or 100% by weight, based on the total weight of alkylene oxide used to prepare the aromatic amine-initiated polyether polyol, and ethylene oxide is present in an amount of no more than 10% by weight, no more than 5% by weight, no more than 1% by weight, or 0% by weight, based on the total weight of alkylene oxide used to prepare the aromatic amine-initiated polyether polyol.

Clause 67. The polyurethane foam-forming composition of one of clause 50 to clause 66, wherein the aromatic amine-initiated polyether polyol has an OH number of 300 to 500 mg KOH/g, 350 to 450 mg KOH/g or 380 to 420 mg KOH/g, and/or a functionality of 2.5 to 4.5, 3.5 to 4.5, 3.8 to 4.2 or 4.0.

Clause 68. The polyurethane foam-forming composition of one of clause 50 to clause 67, wherein the aromatic amine-initiated polyether polyol has a content of —C₂H₄O— units of less than 10% by weight, less than 5% by weight, less than 2% by weight, or 0% by weight, based on total weight of the aromatic amine-initiated polyether polyol.

Clause 69. The polyurethane foam-forming composition of one of clause 50 to clause 68, wherein the aromatic amine-initiated polyether polyol is present in an amount of 1% to 25% by weight, 10% to 20% by weight, or 10% to 15% by weight, based on the total weight of the polyol blend.

Clause 70. The polyurethane foam-forming composition of one of clause 50 to clause 69, wherein the polyol blend further comprises an aromatic polyester polyol.

Clause 71. The polyurethane foam-forming composition of clause 70, wherein the aromatic polyester polyol has an OH number of 150 to 410 mg KOH/g, 150 to 360 mg KOH/g, 200 to 335 mg KOH/g, or 200 to 250 mg KOH/g, and a functionality of 1.5 to 3 or 1.9 to 2.5.

Clause 72. The polyurethane foam-forming composition of clause 70 or clause 71, wherein the aromatic polyester polyol has a content of —C₂H₄O— units of less than 50% by weight, based on total weight of the aromatic polyester polyol.

Clause 73. The polyurethane foam-forming composition of one of clause 70 to clause 72, wherein the aromatic polyester polyol is present in an amount of up to 10% by weight, 1 to 10% by weight, or 5 to 10% by weight, based on total weight of the polyol blend.

Clause 74. The polyurethane foam-forming composition of one of clause 50 to clause 73, wherein the polyol blend further comprises an alkanolamine-initiated polyether polyol comprising a reaction product of an alkylene oxide with an H-functional initiator comprising an alkanolamine.

Clause 75. The polyurethane foam-forming composition of clause 74, wherein the alkanolamine is represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms, wherein the dialkylene ether radical is represented by the formula:

R—O—R—

where each R represents a hydrocarbon radical having 2 to 3 carbon atoms, such as where the alkanolamine comprises monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, or a mixture of any two or more thereof.

Clause 76. The polyurethane foam-forming composition of clause 74 or clause 75, wherein the alkanolamine is present in an amount of more than 50% by weight, at least 80% by weight, at least 90% by weight, or 100% by weight, based on the total weight of H-functional initiator used to produce the alkanolamine-initiated polyether polyol.

Clause 77. The polyurethane foam-forming composition of one of clause 74 to clause 76, wherein the propylene oxide is present in an amount of more than 50% by weight, at least 80% by weight, at least 90% by weight, or 100% by weight, based on the total weight of alkylene oxide used to prepare the alkanolamine-initiated polyether polyol, and ethylene oxide is present in an amount of no more than 10% by weight, no more than 5% by weight, no more than 1% by weight, or 0% by weight, based on the total weight of alkylene oxide used to prepare the alkanolamine-initiated polyether polyol

Clause 78. The polyurethane foam-forming composition of one of clause 74 to clause 77, wherein the alkanolamine-initiated polyether polyol has an OH number of more than 500 mg KOH/g, more than 500 to 900 mg KOH/g, 600 to 800 mg KOH/g, or 680 to 720 mg KOH/g, and a functionality of 2.5 to 4 or 2.5 to 3.5.

Clause 79. The polyurethane foam-forming composition of one of clause 74 to clause 78, wherein the alkanolamine-initiated polyether polyol is present in an amount of 0.1 to 10% by weight, 1% to 10% by weight, or 5% to 10% by weight, based upon the total weight of the polyol blend.

Clause 80. The polyurethane foam-forming composition of one of clause 74 to clause 79, wherein the alkanolamine-initiated polyether polyol has a content of —C₂H₄O— units of less than 10% by weight, less than 5% by weight, less than 2% by weight, or 0% by weight, based on total weight of the alkanolamine-initiated polyether polyol.

Clause 81. The polyurethane foam-forming composition of one of clause 50 to clause 80, wherein the first hydroxyl-initiated polyether polyol and the second hydroxyl-initiated polyether polyol are present in a weight ratio of 1:5 to 5:1, 1:1 to 5:1, 1:1 to 3:1 or 1.5:1 to 2.5:1.

Clause 82. The polyurethane foam-forming composition of one of clause 50 to clause 81, wherein the first hydroxyl-initiated polyether polyol and the aromatic amine-initiated polyether polyol are present in a weight ratio of 1:1 to 5:1, 1:1 to 4:1, 1:1 to 3:1, or 2:1 to 3:1.

Clause 83. The polyurethane foam-forming composition of one of clause 50 to clause 82, wherein the second hydroxyl-initiated polyether polyol and the aromatic amine-initiated polyether polyol are present in a weight ratio of 1:2 to 2:1, 1:1 to 2:1, or 1:1 to 1.5:1.

Clause 84. The polyurethane foam-forming composition of one of clause 50 to clause 83, wherein the polyol blend has a weighted average functionality of 3 to 5, 3.0 to 4.0, or 3.3 to 3.7, and/or a weighted average hydroxyl number of 300 to 500 mg KOH/g or 350 to 450 mg KOH/g.

Clause 85. The polyurethane foam-forming composition of one of clause 50 to clause 84, wherein the polyol blend is present in an amount of at least 50% by weight, 50 to 90% by weight or 60 to 80% by weight, based on the total weight of the polyurethane foam-forming composition except for the weight of the polyisocyanate.

Clause 86. The polyurethane foam-forming composition of one of clause 50 to clause 85, wherein the polyol blend has a content of —C₂H₄O— units of 1 to 3% by weight or 1.5 to 2.5% by weight, based on total weight of the polyurethane foam-forming composition.

Clause 87. The polyurethane foam-forming composition of one of clause 50 to clause 86, wherein the sum of the amount of the first hydroxyl-initiated polyether polyol, second hydroxyl-initiated polyether polyol, aromatic amine-initiated polyether polyol, and alkanolamine-initiated polyether polyol is at least 90% by weight, at least 95% by weight, at least 98% by weight, or 100% by weight, based on the total weight of the polyol blend.

Clause 88. The polyurethane foam-forming composition of one of clause 50 to clause 87, wherein the polyol blend does not include any filled polyol.

Clause 89. The polyurethane foam-forming composition of one of clause 50 to clause 88, wherein the HCFO comprises 1-chloro-3,3,3-trifluoropropene, 2-chloro-3,3,3-trifluoropropene, 1,2-dichloro-1,2-difluoroethene, 3,3-dichloro-3-fluoropropene, 2-chloro-1,1,1,4,4,4-hexafluorobutene-2, 2-chloro-1,1,1,3,4,4,4-heptafluorobutene-2, or a mixture of any two or more thereof.

Clause 90. The polyurethane foam-forming composition of one of clause 50 to clause 89, wherein the HCFO is present in an amount of 10% to 20% by weight, 10 to 15% by weight or 12 to 14% by weight, based on the total weight of the polyurethane foam-forming composition except for the weight of the polyisocyanate.

Clause 91. The polyurethane foam-forming composition of one of clause 50 to clause 90, wherein the HCFO is present in amount of at least 80% by weight, at least 90% by weight, at least 95% by weight, at least 99% by weight or 100% by weight, based on the total weight of the physical blowing agent in the blowing agent composition.

Clause 92. The polyurethane foam-forming composition of one of clause 50 to clause 91, wherein the water is present in an amount of 1.0% to 5.0% by weight, 1.0% to 3.0% by weight, 2.0 to 3.0% by weight, or 2.1 to 2.5% by weight, based on the total weight of the polyurethane foam-forming composition except for the weight of the polyisocyanate.

Clause 93. The polyurethane foam-forming composition of one of clause 50 to clause 92, wherein the physical blowing agent composition and the water are present in a relative ratio, by weight, of 4:1 to 50:1, 5:1 to 50:1, 5:1 to 20:1, 5:1 to 9:1 or 5:1 to 6:1.

Clause 94. The polyurethane foam-forming composition of one of clause 50 to clause 93, further comprising a tertiary amine comprising a morpholine, an imidazole, or a combination thereof, such as where the tertiary amine comprises: (i) 80% to 100%, 80% to 99% by weight, 90 to 100% by weight, or, in some cases, 95 to 100% by weight, based on the total weight of the tertiary amine catalyst composition, of a morpholine; and (ii) up to 20% by weight, up to 10% by weight, or, in some cases, up to 5% by weight or up to 3% by weight, based on the total weight of the tertiary amine catalyst composition, of an imidazole.

Clause 95. The polyurethane foam-forming composition of clause 94, wherein the morpholine comprises dimorpholinodiethylether, dimorpholinodimethylether, N-ethylmorpholine, N-methylmorpholine, or a mixture of any two or more thereof, and the imidazole comprises imidazole, n-methylimidazole, 1,2-dimethylimidazole, or a mixture of any two or more thereof, such as a mixture of dimorpholinodiethylether and N-methylmorpholine wherein the dimorpholinodiethylether is utilized in an amount of 30 to 80% by weight or 40 to 80% by weight, and N-methylmorpholine is utilized in an amount of 20 to 70% by weight or 20 to 60% by weight, based on the total weight of morpholine.

Clause 96. The polyurethane foam-forming composition of clause 94 or clause 95, wherein the tertiary amine is present in an amount of 1 to 5% by weight, 2.0 to 4.0%, or 2.0 to 3.0% by weight, based on the total weight of the polyurethane foam-forming composition except for the weight of the polyisocyanate.

Clause 97. The polyurethane foam-forming composition of one of clause 50 to clause 96, wherein the polyisocyanate is present in an amount sufficient to provide an isocyanate index of 1.0 to less than 1.5 or 1.0 to 1.1.

Clause 98. The polyurethane foam-forming composition of one of clause 50 to clause 97, wherein the polyisocyanate comprises a methylene-bridged polyphenyl polyisocyanate and/or a prepolymer of a methylene-bridged polyphenyl polyisocyanate having an average functionality of 1.8 to 3.5 or 2.0 to 3.1 isocyanate moieties per molecule and an NCO content of 25 to 32% by weight.

Clause 99. A polyurethane foam-formed from the polyurethane foam-forming composition of one of clause 50 to clause 98, wherein the polyurethane foam has a closed-cell content of more than 80 percent, more than 85 percent, or more than 88 percent, as measured according to ASTM D6226-15 and/or has a thermal conductivity measured at 35° F. (2° C.) of less than 0.126 BTU-in/h-ft²-° F. and measured at 75° F. (24° C.) of less than 0.140 BTU-in/h-ft²-° F. for foam from the core of 2-inch thick panels, as measured according to ASTM C518-15.

Clause 100. A composite article comprising the polyurethane foam of clause 99 sandwiched between facer substrates, wherein the facer substrates comprise plastic (such a polypropylene resin reinforced with continuous bi-directional glass fibers or a fiberglass reinforced polyester copolymer), paper, wood, or metal.

Clause 101. A method of producing a polyurethane foam, comprising reacting, at an isocyanate index of 0.9 to 1.5, a polyurethane foam-forming composition comprising: (a) a polyol blend comprising: (1) 30% to 98% by weight, based on total weight of the polyol blend, of a hydroxyl-initiated polyether polyol having a functionality of 1.5 to less than 4.0 and an OH number of 200 to 600 mg KOH/g; (2) 1 to 40% by weight, based on total weight of the polyol blend, of a hydroxyl-initiated polyether polyol having a functionality of 4.0 to 8 and an OH number of 300 to 600 mg KOH/g; and (3) 1 to 30% by weight, based on total weight of the polyol blend, of an aromatic amine-initiated polyether polyol having a functionality of at least 2.5 and an OH number of 200 to 600 mg KOH/g, wherein the polyol blend has a content of —C₂H₄O— units of 2 to 8% by weight, based on the total weight of the polyol blend; (b) a blowing agent composition comprising: (1) a physical blowing agent and (2) water, in which (i) the water is present in an amount of at least 1% by weight, based on the total weight of the polyurethane foam-forming composition except for the weight of the polyisocyanate, (ii) the physical blowing agent comprises a hydrochlorofluoroolefin that is present in an amount of 5 to 25% by weight, based on total weight of the polyurethane foam-forming composition except for the weight of the polyisocyanate, and in an amount of at least 80% by weight, based on total weight of the physical blowing agent present in the blowing agent composition; and (iii) the physical blowing agent and the water are present in a relative ratio, by weight, of at least 4:1; and (c) a polyisocyanate.

Clause 102. The method of clause 101, wherein the first hydroxyl-initiated polyether polyol has a functionality of 1.5 to 3.5, 2.5 to 3.5, or 2.8 to 3.2, and/or an OH number of 300 to 500 mg KOH/g, 350 to 450 mg KOH/g, or 350 to 400 mg KOH/g.

Clause 103. The method of clause 101 or clause 102, wherein the second such polyether polyol has a functionality of 4.0 to 8.0, 4.5 to 6.5, 5.0 to 6.0, or 5.3 to 5.7, and an OH number of 300 to 600 mg KOH/g, 300 to 500 mg KOH/g, 350 to 450 mg KOH/g, or 350 to 400 mg KOH/g.

Clause 104. The method of one of clause 101 to clause 103, wherein the first hydroxyl-initiated polyether polyol and the second hydroxyl-initiated polyether polyol are an addition product of alkylene oxide onto one or more OH-functional initiators, wherein the addition reaction optionally occurs in the presence of a suitable catalyst, such as a basic catalyst or a DMC catalyst.

Clause 105. The method of clause 104, wherein the OH-functional initiator comprises water, ethylene glycol, diethylene glycol, butyl diglycol, glycerol, diethylene glycol, trimethylolpropane, propylene glycol, pentaerythritol, sorbitol, sucrose, triethanolamine, 1,4-butanediol, 1,6-hexanediol, a low molecular weight hydroxyl-containing ester of such polyols with dicarboxylic acids, or any mixture of any two or more thereof.

Clause 106. The method of clause 104 or clause 105, wherein the OH-functional initiator is present in an amount of more than 50% by weight, at least 80% by weight, at least 90% by weight, or 100% by weight, based on the total weight of H-functional initiator used to produce the first hydroxyl-initiated polyether polyol and/or the second hydroxyl-initiated polyether polyol.

Clause 107. The method of one of clause 104 to clause 106, wherein propylene oxide is present in an amount of more than 50% by weight, at least 60% by weight, at least 70% by weight, at least 80% by weight, at least 90% by weight, or 100% by weight, based on the total weight of alkylene oxide used to prepare the first hydroxyl-initiated polyether polyol and/or the second hydroxyl-initiated polyether polyol.

Clause 108. The method of one of clause 104 to clause 107, wherein ethylene oxide is present in an amount of less than 50% by weight, no more than 40% by weight, no more than 30% by weight, no more than 20% by weight, no more than 10% by weight, no more than 5% by weight, no more than 1% by weight, or 0% by weight, based on the total weight of alkylene oxide used to prepare the first hydroxyl-initiated polyether polyol and/or the second hydroxyl-initiated polyether polyol.

Clause 109. The method of one of clause 104 to clause 108, wherein propylene oxide is present in an amount of at least 80% by weight, at least 90% by weight, or 100% by weight, based on the total weight of alkylene oxide used to prepare the first hydroxyl-initiated polyether polyol and ethylene oxide is present in an amount of no more than 20% by weight, no more than 10% by weight, no more than 5% by weight, no more than 1% by weight, or 0% by weight, based on the total weight of alkylene oxide used to prepare the first hydroxyl-initiated polyether polyol.

Clause 110. The method of one of clause 104 to clause 109, wherein propylene oxide is present in an amount of 60 to 90% by weight, 60 to 80% by weight, or 65 to 75% by weight, based on the total weight of alkylene oxide used to prepare the second hydroxyl-initiated polyether polyol and ethylene oxide is used in an amount of 10% to 40% by weight, 20 to 40% by weight, or 25 to 35% by weight, based on the total weight of alkylene oxide used to prepare the second hydroxyl-initiated polyether polyol.

Clause 111. The method of one of clause 101 to clause 110, wherein the first hydroxyl-initiated polyether polyol is present in an amount of 30% to 80% by weight, 30% to 70% by weight, 40% to 60% by weight, or 45% to 55% by weight, based on total weight of the polyol blend.

Clause 112. The method of one of clause 101 to clause 111, wherein the second hydroxyl-initiated polyether polyol is present in an amount of 10% by to 40% by weight, or 20% to 30% by weight, based on total weight of the polyol blend.

Clause 113. The method of one of clause 101 to clause 112, wherein the first hydroxyl-initiated polyether polyol has a content of —C₂H₄O— units of less than 10% by weight, less than 5% by weight, less than 2% by weight, or 0% by weight, based on total weight of the first hydroxyl-initiated polyether polyol.

Clause 114. The method of one of clause 101 to clause 113, wherein the second hydroxyl-initiated polyether polyol has a content of —C₂H₄O— units of 10% to 50% by weight, such as 10% to 40% by weight, 10% to 30% by weight, or 15% to 25% by weight, based on total weight of the second hydroxyl-initiated polyether polyol.

Clause 115. The method of one of clause 101 to clause 114, wherein the aromatic amine-initiated polyether polyol is a reaction product of an H-functional initiator comprising an aromatic amine with alkylene oxide, such as where the aromatic amine comprises o-TDA.

Clause 116. The method of clause 115, wherein the aromatic amine is present in an amount of more than 50% by weight, at least 80% by weight, at least 90% by weight, or 100% by weight, based on the total weight of H-functional initiator used to produce the aromatic amine-initiated polyether polyol.

Clause 117. The method of clause 115 or clause 116, wherein propylene oxide is present in an amount of more than 50% by weight, at least 80% by weight, at least 90% by weight, or 100% by weight, based on the total weight of alkylene oxide used to prepare the aromatic amine-initiated polyether polyol, and ethylene oxide is present in an amount of no more than 10% by weight, no more than 5% by weight, no more than 1% by weight, or 0% by weight, based on the total weight of alkylene oxide used to prepare the aromatic amine-initiated polyether polyol.

Clause 118. The method of one of clause 101 to clause 117, wherein the aromatic amine-initiated polyether polyol has an OH number of 300 to 500 mg KOH/g, 350 to 450 mg KOH/g or 380 to 420 mg KOH/g, and/or a functionality of 2.5 to 4.5, 3.5 to 4.5, 3.8 to 4.2 or 4.0.

Clause 119. The method of one of clause 101 to clause 118, wherein the aromatic amine-initiated polyether polyol has a content of —C₂H₄O— units of less than 10% by weight, less than 5% by weight, less than 2% by weight, or 0% by weight, based on total weight of the aromatic amine-initiated polyether polyol.

Clause 120. The method of one of clause 101 to clause 119, wherein the aromatic amine-initiated polyether polyol is present in an amount of 1% to 25% by weight, 10% to 20% by weight, or 10% to 15% by weight, based on the total weight of the polyol blend.

Clause 121. The method of one of clause 101 to clause 120, wherein the polyol blend further comprises an aromatic polyester polyol.

Clause 122. The method of clause 121, wherein the aromatic polyester polyol has an OH number of 150 to 410 mg KOH/g, 150 to 360 mg KOH/g, 200 to 335 mg KOH/g, or 200 to 250 mg KOH/g, and a functionality of 1.5 to 3 or 1.9 to 2.5.

Clause 123. The method of clause 121 or clause 122, wherein the aromatic polyester polyol has a content of —C₂H₄O— units of less than 50% by weight, based on total weight of the aromatic polyester polyol.

Clause 124. The method of one of clause 121 to clause 123, wherein the aromatic polyester polyol is present in an amount of up to 10% by weight, 1 to 10% by weight, or 5 to 10% by weight, based on total weight of the polyol blend.

Clause 125. The method of one of clause 101 to clause 124, wherein the polyol blend further comprises an alkanolamine-initiated polyether polyol comprising a reaction product of an alkylene oxide with an H-functional initiator comprising an alkanolamine.

Clause 126. The method of clause 125, wherein the alkanolamine is represented by the formula:

NH₂—Z—OH

in which Z represents a divalent radical which is a straight chain or branched chain alkylene radical having 2 to 6 carbon atoms, a cycloalkylene radical having 4 to 6 carbon atoms or a dialkylene ether radical having 4 to 6 carbon atoms, wherein the dialkylene ether radical is represented by the formula:

—R—O—R—

where each R represents a hydrocarbon radical having 2 to 3 carbon atoms, such as where the alkanolamine comprises monoethanolamine, 1-amino-2-propanol, 2-amino-1-propanol, 3-amino-1-propanol, 1-(2-aminoethoxy) ethanol, 1-amino-2-butanol, 2-amino-3-butanol, 2-amino-2-methylpropanol, 5-amino pentanol, 3-amino-2, 2-dimethyl propanol, 4-aminocyclohexanol, or a mixture of any two or more thereof.

Clause 127. The method of clause 125 or clause 126, wherein the alkanolamine is present in an amount of more than 50% by weight, at least 80% by weight, at least 90% by weight, or 100% by weight, based on the total weight of H-functional initiator used to produce the alkanolamine-initiated polyether polyol.

Clause 128. The method of one of clause 125 to clause 127, wherein the propylene oxide is present in an amount of more than 50% by weight, at least 80% by weight, at least 90% by weight, or 100% by weight, based on the total weight of alkylene oxide used to prepare the alkanolamine-initiated polyether polyol, and ethylene oxide is present in an amount of no more than 10% by weight, no more than 50% by weight, no more than 1% by weight, or 0% by weight, based on the total weight of alkylene oxide used to prepare the alkanolamine-initiated polyether polyol.

Clause 129. The method of one of clause 125 to clause 128, wherein the alkanolamine-initiated polyether polyol has an OH number of more than 500 mg KOH/g, more than 500 to 900 mg KOH/g, 600 to 800 mg KOH/g, or 680 to 720 mg KOH/g, and a functionality of 2.5 to 4 or 2.5 to 3.5.

Clause 130. The method of one of clause 125 to clause 129, wherein the alkanolamine-initiated polyether polyol is present in an amount of 0.1 to 10% by weight, 1% to 10% by weight, or 5% to 10% by weight, based upon the total weight of the polyol blend.

Clause 131. The method of one of clause 125 to clause 130, wherein the alkanolamine-initiated polyether polyol has a content of —C₂H₄O— units of less than 10% by weight, less than 5% by weight, less than 2% by weight, or 0% by weight, based on total weight of the alkanolamine-initiated polyether polyol.

Clause 132. The method of one of clause 101 to clause 131, wherein the first hydroxyl-initiated polyether polyol and the second hydroxyl-initiated polyether polyol are present in a weight ratio of 1:5 to 5:1, 1:1 to 5:1, 1:1 to 3:1 or 1.5:1 to 2.5:1.

Clause 133. The method of one of clause 101 to clause 132, wherein the first hydroxyl-initiated polyether polyol and the aromatic amine-initiated polyether polyol are present in a weight ratio of 1:1 to 5:1, 1:1 to 4:1, 1:1 to 3:1, or 2:1 to 3:1.

Clause 134. The method of one of clause 101 to clause 133, wherein the second hydroxyl-initiated polyether polyol and the aromatic amine-initiated polyether polyol are present in a weight ratio of 1:2 to 2:1, 1:1 to 2:1, or 1:1 to 1.5:1.

Clause 135. The method of one of clause 101 to clause 134, wherein the polyol blend has a weighted average functionality of 3 to 5, 3.0 to 4.0, or 3.3 to 3.7, and/or a weighted average hydroxyl number of 300 to 500 mg KOH/g or 350 to 450 mg KOH/g.

Clause 136. The method of one of clause 101 to clause 135, wherein the polyol blend is present in an amount of at least 50% by weight, 50 to 90% by weight or 60 to 80% by weight, based on the total weight of the polyurethane foam-forming composition except for the weight of the polyisocyanate.

Clause 137. The method of one of clause 101 to clause 136, wherein the polyol blend has a content of —C₂H₄O— units of 1 to 3% by weight or 1.5 to 2.5% by weight, based on total weight of the polyurethane foam-forming composition.

Clause 138. The method of one of clause 101 to clause 137, wherein the sum of the amount of the first hydroxyl-initiated polyether polyol, second hydroxyl-initiated polyether polyol, aromatic amine-initiated polyether polyol, and alkanolamine-initiated polyether polyol is at least 90% by weight, at least 95% by weight, at least 98% by weight, or 100% by weight, based on the total weight of the polyol blend.

Clause 139. The method of one of clause 101 to clause 138, wherein the polyol blend does not include any filled polyol.

Clause 140. The method of one of clause 101 to clause 139, wherein the HCFO comprises 1-chloro-3,3,3-trifluoropropene, 2-chloro-3,3,3-trifluoropropene, 1,2-dichloro-1,2-difluoroethene, 3,3-dichloro-3-fluoropropene, 2-chloro-1,1,1,4,4,4-hexafluorobutene-2, 2-chloro-1,1,1,3,4,4,4-heptafluorobutene-2, or a mixture of any two or more thereof.

Clause 141. The method of one of clause 101 to clause 140, wherein the HCFO is present in an amount of 10% to 20% by weight, 10 to 15% by weight or 12 to 14% by weight, based on the total weight of the polyurethane foam-forming composition except for the weight of the polyisocyanate.

Clause 142. The method of one of clause 101 to clause 141, wherein the HCFO is present in amount of at least 80% by weight, at least 90% by weight, at least 95% by weight, at least 99% by weight or 100% by weight, based on the total weight of the physical blowing agent in the blowing agent composition.

Clause 143. The method of one of clause 101 to clause 142, wherein the water is present in an amount of 1.0% to 5.0% by weight, 1.0% to 3.0% by weight, 2.0 to 3.0% by weight, or 2.1 to 2.5% by weight, based on the total weight of the polyurethane foam-forming composition except for the weight of the polyisocyanate.

Clause 144. The method of one of clause 101 to clause 143, wherein the physical blowing agent composition and the water are present in a relative ratio, by weight, of 4:1 to 50:1, 5:1 to 50:1, 5:1 to 20:1, 5:1 to 9:1 or 5:1 to 6:1.

Clause 145. The method of one of clause 101 to clause 144, further comprising a tertiary amine comprising a morpholine, an imidazole, or a combination thereof, such as where the tertiary amine comprises: (i) 80% to 100%, 80% to 99% by weight, 90 to 100% by weight, or, in some cases, 95 to 100% by weight, based on the total weight of the tertiary amine catalyst composition, of a morpholine; and (ii) up to 20% by weight, up to 10% by weight, or, in some cases, up to 5% by weight or up to 3% by weight, based on the total weight of the tertiary amine catalyst composition, of an imidazole.

Clause 146. The method of clause 145, wherein the morpholine comprises dimorpholinodiethylether, dimorpholinodimethylether, N-ethylmorpholine, N-methylmorpholine, or a mixture of any two or more thereof, and the imidazole comprises imidazole, n-methylimidazole, 1,2-dimethylimidazole, or a mixture of any two or more thereof, such as a mixture of dimorpholinodiethylether and N-methylmorpholine wherein the dimorpholinodiethylether is utilized in an amount of 30 to 80% by weight or 40 to 80% by weight, and N-methylmorpholine is utilized in an amount of 20 to 70% by weight or 20 to 60% by weight, based on the total weight of morpholine.

Clause 147. The method of clause 145 or clause 146, wherein the tertiary amine is present in an amount of 1 to 5% by weight, 2.0 to 4.0%, or 2.0 to 3.0% by weight, based on the total weight of the polyurethane foam-forming composition except for the weight of the polyisocyanate.

Clause 148. The method of one of clause 101 to clause 147, wherein the polyisocyanate is present in an amount sufficient to provide an isocyanate index of 1.0 to less than 1.5 or 1.0 to 1.1.

Clause 149. The method of one of clause 101 to clause 148, wherein the polyisocyanate comprises a methylene-bridged polyphenyl polyisocyanate and/or a prepolymer of a methylene-bridged polyphenyl polyisocyanate having an average functionality of 1.8 to 3.5 or 2.0 to 3.1 isocyanate moieties per molecule and an NCO content of 25 to 32% by weight.

Clause 150. A polyurethane foam produced by the method of one of clause 101 to clause 149, wherein the polyurethane foam has a closed-cell content of more than 80 percent, more than 85 percent, or more than 88 percent, as measured according to ASTM D6226-15 and/or has a thermal conductivity measured at 35° F. (2° C.) of less than 0.126 BTU-in/h-ft2-° F. and measured at 75° F. (24° C.) of less than 0.140 BTU-in/h-ft2-° F. for foam from the core of 2-inch thick panels, as measured according to ASTM C518-15.

Clause 151. A composite article comprising the polyurethane foam of clause 150 sandwiched between facer substrates, wherein the facer substrates comprise plastic (such a polypropylene resin reinforced with continuous bi-directional glass fibers or a fiberglass reinforced polyester copolymer), paper, wood, or metal.

The non-limiting and non-exhaustive examples that follow are intended to further describe various non-limiting and non-exhaustive implementations without restricting the scope of the implementations described in this specification.

### EXAMPLES

Foam-forming compositions were prepared using the ingredients and amounts (in parts by weight) set forth in Table 1. The following materials were used:
POLYOL 1: a polyether polyol having a hydroxyl number of 410 mg KOH/g and a functionality of 4.3, prepared by alkoxylating an H-functional initiator composition of sucrose, glycerin, propylene glycol and water, in which the alkylene oxide is 100% by weight propylene oxide so that the polyether polyol has no —C₂H₄O— units;
POLYOL 2: a polyether polyol having a hydroxyl number of 380 mg KOH/g and a functionality of 3.0, prepared by alkoxylating an H-functional initiator composition of sucrose, propylene glycol, and water, in which the alkylene oxide is 100% by weight propylene oxide so that the polyether polyol has no —C₂H₄O— units;
POLYOL 3: a polyether polyol having a hydroxyl number of 60 mg KOH/g and a functionality of 4, prepared by alkoxylating ethylenediamine, in which the alkylene oxide is 100% propylene oxide so that the polyether polyol has no —C₂H₄O— units;
POLYOL 4: a polyether polyol having a hydroxyl number of 112 mg KOH/g and a functionality of 3, prepared by alkoxylating glycerin, in which the alkylene oxide is 100% propylene oxide so that the polyether polyol has no —C₂H₄O— units;
POLYOL 5: a polyether polyol having a hydroxyl number of 700 mg KOH/g and a functionality of 3, prepared by alkoxylating monoethanolamine, in which the alkylene oxide is 100% propylene oxide so that the polyether polyol has no —C₂H₄O— units;
POLYOL 6: a polyether polyol having a hydroxyl number of 470 mg KOH/g and a functionality of 5.5, prepared by alkoxylated an H-functional initiator composition of sucrose and water, in which the alkylene oxide is 15% by weight ethylene oxide and 85% by weight propylene oxide so that the polyether polyol has a content of —C₂H₄O— units of 21.10% by weight, based on total weight of the polyether polyol;
POLYOL 7: a polyether polyol having a hydroxyl number of 360 mg KOH/g and a functionality of 3.6, prepared by alkoxylating o-TDA, in which the alkylene oxide is 100% by weight propylene oxide so that the polyether polyol has no content of —C₂H₄O— units POLYOL 8: an aromatic polyester polyol having an OH number of 240 mg KOH/g and a functionality of 2, and a content of —C₂H₄O— units of 44.9% by weight, based on total weight of the aromatic polyester polyol;
SURFACTANT: TEGOSTAB® B-8499;
CATALYST 1: 2,2′-dimorpholinodiethylether (JEFFCAT® DMDEE from Huntsman);
CATALYST 2: 1,2-dimethylimidazole (DABCO® 2041 from Evonik);
CATALYST 3: N-methylmorpholine (JEFFCAT® NMM from Huntsman);
HCFO: trans-1,1,1-trifluoro-3-chloropropene (Solstice® LBA from Honeywell);
ISOCYANATE: polymeric diphenylmethane diisocyanate (pMDI); NCO content 31.3%; viscosity 150-250 mPa·s@25° C. (MONDUR® MR-LIGHT from Covestro).

### Examples 1-11

In each case a master batch was prepared by mixing the polyols, catalysts, surfactant, water and blowing agents in the amounts indicated in Table 1. Foams were prepared by mixing the masterbatch with the amount of isocyanate indicated in Table 1 and pouring the mixture into an 83-ounce paper cup. The cream time, gel time, tack-free time and free rise density (FRD) were recorded. Results are set forth in Table 1 (reported results represent the average results of three replicate experiments). N/A indicates that a representative sample was not tested. Laboratory panel foams were made by targeting a foam density range of 2.18 to 2.22 lb/ft² (30.4 to 33.6 kg/m³) inside a given enclosed volume size of 13 in×25 in×3 in thick (33 cm×63.5 cm×7.6 cm). The foams were then tested for thermal conductivity per C518 method with cold plate at 15° F. and hot plate at 55° F. for an average of 35° F. result, then with cold plate at 55° F. and hot plate at 95° F. for an average of 75° F. result. Core density was measured on each of the thermal conductivity samples per ASTM D1622 method along with the % open/closed cell content per ASTM D6226 method. Compressive strength, perpendicular and parallel samples were measured on the remainder of the foam panel per ASTM D1621 method. Blend stability was a visual inspection of the master batch each day after the initial blend was made. A (−) was a blend that would develop a separation layer or layers any time before 60 days, a (+) was a blend that had no separation layers during the 60 days period.

Results are set forth in Table 1. Examples 1-9 are comparative examples and Examples 10-12 are inventive examples.

TABLE 1

| | Example | | | | | | | | | | | |
|---|---|---|---|---|---|---|---|---|---|---|---|---|
| Ingredient | 1 | 2 | 3 | 4 | 5 | 6 | 7 | 8 | 9 | 10 | 11 | 12 |
| POLYOL 1 | 64.56 | 34.56 | 24.56 | 35.05 | 24.90 | 24.90 | 35.38 | 35.50 | 35.70 | — | — | — |
| POLYOL 2 | — | — | — | — | — | — | — | — | — | 39.90 | 48.30 | 43.31 |
| POLYOL 3 | 4.30 | 4.30 | 4.30 | 4.36 | 4.36 | 4.36 | 4.41 | 4.41 | 4.41 | — | — | — |
| POLYOL 4 | 4.00 | 4.00 | 4.00 | 4.06 | 4.05 | 4.05 | 4.10 | 4.10 | 4.10 | — | — | — |
| POLYOL 5 | 5.00 | 5.00 | 5.00 | 5.07 | 5.07 | 5.07 | 5.12 | 5.12 | 5.12 | 4.99 | 5.00 | 7.00 |
| POLYOL 6 | — | 30.00 | 40.00 | 30.40 | 40.56 | 40.56 | 30.69 | 30.70 | 30.70 | 19.95 | 11.50 | 20.00 |
| POLYOL 7 | — | — | — | — | — | — | — | — | — | 14.97 | 10.00 | 10.00 |
| POLYOL 8 | — | — | — | — | — | — | — | — | — | — | 5.00 | — |
| SURFACTANT | 2.00 | 2.00 | 2.00 | 2.00 | 2.00 | 2.00 | 2.00 | 2.00 | 2.00 | 2.00 | 2.00 | 2.00 |
| CATALYST 1 | 1.90 | 1.90 | 1.90 | 1.90 | 1.90 | 1.90 | 1.90 | 1.90 | 1.90 | 1.90 | 1.90 | 1.80 |
| CATALYST 2 | 0.25 | 0.25 | 0.25 | 0.25 | 0.25 | 0.25 | 0.25 | 0.15 | 0.05 | 0.05 | 0.05 | — |
| CATALYST 3 | 0.70 | 0.70 | 0.70 | 0.70 | 0.70 | 0.70 | 0.70 | 0.70 | 0.70 | 0.70 | 0.70 | 0.35 |
| Water | 1.90 | 1.90 | 1.90 | 2.21 | 2.21 | 2.21 | 2.45 | 2.42 | 2.42 | 2.37 | 2.35 | 2.37 |
| HCFO | 15.39 | 15.39 | 15.39 | 14.00 | 14.00 | 14.00 | 13.00 | 13.00 | 12.90 | 13.17 | 13.20 | 13.17 |
| ISOCYANATE | 110.00 | 110.00 | 110.00 | 116.00 | 116.00 | 116.00 | 121.00 | 121.00 | 121.00 | 121.00 | 120.00 | 123.00 |
| % EO Content in | 0.0 | 6.3 | 8.4 | 6.4 | 8.6 | 8.6 | 6.5 | 6.5 | 6.5 | 4.2 | 4.7 | 4.2 |
| Polyols¹ | | | | | | | | | | | | |
| % EO Content in Foam² | 0.0 | 3.0 | 4.0 | 3.0 | 4.0 | 4.0 | 2.9 | 2.9 | 2.9 | 1.9 | 2.1 | 1.9 |
| Blend Stability³ | + | − | − | − | − | − | − | − | − | + | + | + |
| Cream Time (sec) | 16 | 18 | 19 | 16 | 18 | 18 | 17 | 17 | 17 | 14 | 16 | 16 |
| Top of Cup (sec) | 72 | 76 | 72 | 67 | 67 | 67 | 60 | 64 | 68 | N/A | 72 | N/A |
| Gel Time (sec) | 139 | 135 | 129 | 128 | 130 | 130 | 111 | 122 | 131 | 112 | 139 | 134 |
| Tack-Free Time (sec) | 215 | 198 | 198 | 183 | 182 | 182 | 192 | 212 | 194 | 260 | 215 | 255 |
| Cup Density (lb/ft³) | 1.72 | 1.61 | 1.66 | 1.66 | 1.65 | 1.65 | 1.6 | 1.64 | 1.58 | 1.73 | 1.72 | 1.61-1.65 |
| Core Density (lb/ft³) | 1.99 | 2.09 | 2.04 | 2.00 | 2.02 | 1.84 | 1.96 | 2.02 | 2.06 | N/A | N/A | 1.97 |
| Fox k-factor (15PLATE- | 0.129 | 0.128 | 0.127 | 0.127 | 0.131 | 0.134 | 0.131 | 0.128 | 0.131 | 0.129 | 0.131 | 0.130 |
| 55PLATE), | | | | | | | | | | | | |
| BTU · in/h · ft² · ° F. | | | | | | | | | | | | |
| Fox k-factor (55PLATE- | 0.149 | 0.145 | 0.144 | 0.146 | 0.151 | 0.154 | 0.149 | 0.147 | 0.150 | 0.147 | 0.150 | 0.150 |
| 95PLATE), | | | | | | | | | | | | |
| BTU · in/h · ft² · ° F. | | | | | | | | | | | | |
| % Closed-Cell | 87.3 | 86.8 | 85.7 | 86.1 | 85.2 | 86.3 | 87.5 | 86.6 | 88.8 | 88.2-88.9 | 88.1-88.5 | 87.0-87.5 |
| Compressive Strength= | 14.8-19.9 | N/A | N/A | N/A | N/A | N/A | N/A | N/A | N/A | 24.01 | 21.89 | N/A |
| Compressive Strength+ | 17.5-21.7 | N/A | N/A | N/A | N/A | N/A | N/A | N/A | N/A | 18.92 | 18.00 | N/A |

¹Reported value is based on total weight of polyols present
²Reported value is based on total weight of the foam-forming composition
³Blend stability was a visual inspection of the master batch each day after the initial blend was made up to 60 days. A (−) was a blend that would develop a separation layer or layers any time before 60 days, a (+) was a blend that had no separation layers during the 60 days period.

### Machine Examples 1, 9, 12-13

| | Machine Results | | | |
|---|---|---|---|---|
| Ingredient | 1 | 9 | 13 | 12 |
| POLYOL 1 | 64.56 | 35.7 | 46.52 | — |
| POLYOL 2 | — | — | — | 43.31 |
| POLYOL 3 | 4.3 | 4.41 | 4.41 | |
| POLYOL 4 | 4 | 4.10 | 4.10 | |
| POLYOL 5 | 5 | 5.12 | 5.00 | 7.00 |
| POLYOL 6 | — | 30.70 | 20.00 | 20.00 |
| POLYOL 7 | — | — | — | 10.00 |
| POLYOL 8 | — | — | — | — |
| SURFACTANT | 2 | 2.00 | 2.00 | 2.00 |
| CATALYST 1 | 1.9 | 1.90 | 1.90 | 1.80 |
| CATALYST 2 | 0.25 | 0.05 | 0.05 | — |
| CATALYST 3 | 0.7 | 0.70 | 0.70 | 0.35 |
| Water | 1.9 | 2.42 | 2.42 | 2.37 |
| HCFO | 15.39 | 12.90 | 12.90 | 13.17 |
| ISOCYANATE | 110 | 121 | 118 | 123 |
| % EO Content | 0.0 | 6.5 | 4.2 | 4.2 |
| in Polyols¹ | | | | |
| % EO Content | 0.0 | 2.9 | 1.9 | 1.9 |
| in Foam² | | | | |
| Blend Stability³ | + | − | − | + |
| Cream Time | 16-17 | 17 | 11-18 | 10-14 |
| (sec) | | | | |
| Gel Time (sec) | 120-139 | 108 | 111-119 | 115-128 |
| Tack-Free | 207-215 | 149 | 168-177 | 235 |
| Time (sec) | | | | |
| Free-Rise | 1.58 | 1.54 | N/R | 1.52-1.59 |
| Density (lb/ft³) | | | | |
| Core Density | 1.95-2.04 | 1.92-2.00 | 1.92-1.99 | 1.91-1.96 |
| (lb/ft³) | | | | |
| Fox k-factor | 0.128-0.132 | 0.138 | 0.134-0.135 | 0.131-0.133 |
| (15PLATE- | | | | |
| 55PLATE), | | | | |
| BTU · in/h · | | | | |
| ft² · ° F. | | | | |
| Fox k-factor | 0.147-0.154 | 0.157 | 0.154 | 0.151-0.152 |
| (55PLATE- | | | | |
| 95PLATE), | | | | |
| BTU · in/h · | | | | |
| ft² · ° F. | | | | |
| % Closed-Cell | 87.5-89.4 | 83.2-86.0 | 83.7-85.8 | 86.3-88.8 |
| Compressive | 14.8-19.9 | 22.6 | 22.1 | 29.0-31.0 |
| Strength= | | | | |
| Compressive | 17.5-21.7 | 15 | 18.5 | 18.0-19.5 |
| Strength+ | | | | |
| Dimensional | −0.2 | 0.6 | −0.3 | −0.7⁴ |
| Stability | | | | |
| 28 Days @ | | | | |
| 100 ° C. | | | | |
| Dimensional | −0.4 to −0.2 | −0.7 | 0.3 | 0.1⁴ |
| Stability | | | | |
| 28 Days @ | | | | |
| −30° C. | | | | |
| Dimensional | −0.2 to 1.2 | −0.5 | 0.4 | 0.2⁴ |
| Stability | | | | |
| 28 Days @, | | | | |
| 70° C. at 100% | | | | |
| Rel. Humidity | | | | |

⁴Reported value is after 7 days, not 28 days

Successful laboratory results, such as, examples 9, 12, and 13 were then either prepared using a high-pressure discontinuous foam machine, such as, Cannon A100 or Hennecke HK-1250 high-pressure foam machine. The liquid output was maintained at a constant 21° C. for Polyol and 26.7° C. for Isocyanate side with an output range of 550 to 600 grams/second with a pour pressure of 103 bar. The minimum fill density was determined from foaming 3 panels poured into a temperature-controlled mold having dimensions of 8 in wide by 78.75 in high by 3.0 in thick (20.3 cm×200 cm×7.6 cm) that didn't fill the mold entirely, then linear regression was used to determine a calculated minimum panel mass value. After the minimum fill density was determined, then foam was packed to obtain desired target density of 2.18 to 2.22 lb/ft³ (30.4 to 33.6 kg/m³) measured according to ASTM D1622 and demolded from the mold between 20-25 minutes. The foams were then tested for thermal conductivity per C518 method with cold plate at 15° F. and hot plate at 55° F. for an average of 35° F. result, then with cold plate at 55° F. and hot plate at 95° F. for an average of 75° F. result. Core density was measured on each of the thermal conductivity samples per ASTM D1622 method along with the % open/closed cell content per ASTM D6226 method. Compressive strength, perpendicular and parallel samples were measured per ASTM D1621 method. Dimensional stabilities were also measured per ASTM D2126 method. Test foam results were then compared to the control example 1 foam results, especially to the thermal conductivity “Fox k-factor” result ranges. Foam systems were considered good if the thermal conductivity “Fox k-factor” was within the control result range and that the results from the other remaining test were similar in comparison to example 1 control results. Examples 14 and 15 were systems adjusted with % EO content 1% lower and 1% higher than example 13 to determine if the EO content of Example 13 was the optimized amount to obtain the lowest foam thermal conductivity possible.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polyurethane foam-forming composition comprising:
(a) a polyol blend comprising:
(1) 30% to 98% by weight, based on total weight of the polyol blend, of a first hydroxyl-initiated polyether polyol having a functionality of 1.5 to less than 4.0 and an OH number of 200 to 600 mg KOH/g;
(2) 1 to 40% by weight, based on total weight of the polyol blend, of a second hydroxyl-initiated polyether polyol having a functionality of 4.0 to 8 and an OH number of 300 to 600 mg KOH/g; and
(3) 1 to 30% by weight, based on total weight of the polyol blend, of an aromatic amine-initiated polyether polyol having a functionality of at least 2.5 and an OH number of 200 to 600 mg KOH/g,
wherein the polyol blend has a content of —C₂H₄O— units of 2 to 8% by weight, based on the total weight of the polyol blend.
(b) a blowing agent composition comprising:
(1) a physical blowing agent; and
(2) water, in which
(i) the water is present in an amount of at least 1% by weight, based on the total weight of the isocyanate-reactive composition,
(ii) the physical blowing agent comprises a hydrochlorofluoroolefin that is present in an amount of 5 to 25% by weight, based on total weight of the isocyanate-reactive composition, and in an amount of at least 80% by weight, based on total weight of the physical blowing agent present in the blowing agent composition; and
(iii) the physical blowing agent and the water are present in a relative ratio, by weight, of at least 4:1.

2. The isocyanate-reactive composition of claim 1, wherein the first hydroxyl-initiated polyether polyol has a functionality of 1.5 to 3.5 and an OH number of 300 to 500 mg KOH/g, and the second polyether polyol has a functionality of 4.5 to 6.5 and an OH number of 300 to 600 mg KOH/g.

3. The isocyanate-reactive composition of claim 2, wherein propylene oxide is present in an amount of at least 90% by weight, based on the total weight of alkylene oxide used to prepare the first hydroxyl-initiated polyether polyol and propylene oxide is present in an amount of 60 to 80% by weight, based on the total weight of alkylene oxide used to prepare the second hydroxyl-initiated polyether polyol.

4. The isocyanate-reactive composition of claim 1, wherein the first hydroxyl-initiated polyether polyol is present in an amount of 30% to 80% by weight, based on total weight of the polyol blend, and the second hydroxyl-initiated polyether polyol is present in an amount of 10% by to 40% by weight, based on total weight of the polyol blend.

5. The isocyanate-reactive composition of claim 1, wherein the aromatic amine-initiated polyether polyol has an OH number of 300 to 500 mg KOH/g and a functionality of 2.5 to 4.5.

6. The isocyanate-reactive composition of claim 1, wherein the aromatic amine-initiated polyether polyol is present in an amount of 10% to 20% by weight, based on the total weight of the polyol blend.

7. The isocyanate-reactive composition of one of claim 1, wherein the polyol blend further comprises an alkanolamine-initiated polyether polyol comprising a reaction product of an alkylene oxide with an H-functional initiator comprising an alkanolamine, wherein the alkanolamine is present in an amount of more than 50% by weight, based on the total weight of H-functional initiator used to produce the alkanolamine-initiated polyether polyol.

8. The isocyanate-reactive composition of claim 7, wherein the alkanolamine-initiated polyether polyol has an OH number of more than 500 mg KOH/g and a functionality of 2.5 to 4.

9. The isocyanate-reactive composition of claim 8, wherein the alkanolamine-initiated polyether polyol is present in an amount of 0.1 to 10% by weight, based upon the total weight of the polyol blend.

10. The isocyanate-reactive composition of claim 1, wherein the polyol blend has a content of —C₂H₄O— units of 3% to 6% by weight, based on total weight of the polyol blend.

11. The isocyanate-reactive composition of claim 7, wherein the sum of the amount of the first hydroxyl-initiated polyether polyol, second hydroxyl-initiated polyether polyol, aromatic amine-initiated polyether polyol, and alkanolamine-initiated polyether polyol is at least 90% by weight, based on the total weight of the polyol blend.

12. The isocyanate-reactive composition of claim 1, wherein the HCFO comprises 1-chloro-3,3,3-trifluoropropene present in an amount of 10% to 20% by weight, based on the total weight of the isocyanate-reactive composition.

13. The isocyanate-reactive composition of one of claim 1, wherein the HCFO is present in amount of at least 90% by weight, based on the total weight of the physical blowing agent in the blowing agent composition.

14. The isocyanate-reactive composition of claim 1, wherein the water is present in an amount of 1.0% to 3.0% by weight, based on the total weight of the isocyanate-reactive composition.

15. The isocyanate-reactive composition of claim 1, further comprising a tertiary amine comprising: (i) 80 to 100% by weight, based on the total weight of the tertiary amine, of a morpholine; and (ii) up to 20% by weight, based on the total weight of the tertiary amine, of an imidazole.

16. A polyurethane foam-forming composition comprising:
(a) polyol blend comprising:
(1) 30% to 98% by weight, based on total weight of the polyol blend, of a first hydroxyl-initiated polyether polyol having a functionality of 1.5 to less than 4.0 and an OH number of 200 to 600 mg KOH/g;
(2) 1 to 40% by weight, based on total weight of the polyol blend, of a second hydroxyl-initiated polyether polyol having a functionality of 4.0 to 8 and an OH number of 300 to 600 mg KOH/g; and
(3) 1 to 30% by weight, based on total weight of the polyol blend, of an aromatic amine-initiated polyether polyol having a functionality of at least 2.5 and an OH number of 200 to 600 mg KOH/g,
herein the polyol blend has a content of —C₂H₄O— units of 2 to 8% by weight, based on the total weight of the polyol blend.
(b) a blowing agent composition comprising:
(1) a physical blowing agent; and
(2) water, in which
(i) the water is present in an amount of at least 1% by weight, based on the total weight of the polyurethane foam-forming composition except for the weight of the polyisocyanate,
(ii) the physical blowing agent comprises a hydrochlorofluoroolefin that is present in an amount of 5 to 25% by weight, based on total weight of the polyurethane foam-forming composition except for the weight of the polyisocyanate, and in an amount of at least 80% by weight, based on total weight of the physical blowing agent present in the blowing agent composition, and
(iii) the physical blowing agent and the water are present in a relative ratio, by weight, of at least 4:1; and
(c) a polyisocyanate is present in an amount sufficient to provide an isocyanate index of 0.9 to 1.5.

17. A method of producing a polyurethane foam comprising reacting, at an isocyanate index of 0.9 to 1.5, a polyurethane foam-forming composition comprising:
(a) a polyol blend comprising:
(1) 30% to 98% by weight, based on total weight of the polyol blend, of a first hydroxyl-initiated polyether polyol having a functionality of 1.5 to less than 4.0 and an OH number of 200 to 600 mg KOH/g;
(2) 1 to 40% by weight, based on total weight of the polyol blend, of a second hydroxyl-initiated polyether polyol having a functionality of 4.0 to 8 and an OH number of 300 to 600 mg KOH/g; and
(3) 1 to 30% by weight, based on total weight of the polyol blend, of an aromatic amine-initiated polyether polyol having a functionality of at least 2.5 and an OH number of 200 to 600 mg KOH/g,
wherein the polyol blend has a content of —C₂H₄O— units of 2 to 8% by weight, based on the total weight of the polyol blend.
(b) a blowing agent composition comprising:
(1) a physical blowing agent; and
(2) water, in which
(i) the water is present in an amount of at least 1% by weight, based on the total weight of the polyurethane foam-forming composition except for the weight of the polyisocyanate,
(ii) the physical blowing agent comprises a hydrochlorofluoroolefin that is present in an amount of 5 to 25% by weight, based on total weight of the polyurethane foam-forming composition except for the weight of the polyisocyanate, and in an amount of at least 80% by weight, based on total weight of the physical blowing agent present in the blowing agent composition; and
(iii) the physical blowing agent and the water are present in a relative ratio, by weight, of at least 4:1; and
(c) a polyisocyanate.
